(19) United States
(12) Patent Application Publication
(10) Pub. No.: US 2019/0108580 A1
(43) Pub. Date: Apr. 11, 2019

(54) Systems, Methods and Apparatuses to Facilitate Trade or Exchange of Virtual Real-Estate Associated With a Physical Space

(71) Applicant: Magical Technologies, LLC, Redmond, WA (US)

(72) Inventors: Nova Spivack, Sherman Oaks, CA (US); Matthew Hoerl, Sherman Oaks, CA (US); Armando Pena, Santa Monica, CA (US)

(21) Appl. No.: 16/052,720

(22) Filed: Aug. 2, 2018

Related U.S. Application Data
(60) Provisional application No. 62/540,120, filed on Aug. 2, 2017.
(60) Provisional application No. 62/557,775, filed on Sep. 13, 2017.

(51) Int. Cl. G06Q 30/08; G06Q 50/16

(52) U.S. Cl. CPC G06Q 30/08; G06Q 50/163

(57) ABSTRACT

Systems, Methods and Apparatuses to facilitate trade or exchange of virtual real-estate associated with a physical space are disclosed. In one aspect, embodiments of the present disclosure include a method, which may be implemented on a system, to administer a marketplace for a virtual world component of an augmented reality environment. The method can further include identifying a unit of virtual real-estate to be traded and/or identify a unit of physical space in the real world which corresponds to the unit of virtual real-estate. An exchange mechanism can be established for trading the unit of virtual real-estate.

### CLAIM OF PRIORITY

This application claims the benefit of:

U.S. Provisional Application No. 62/540,120, filed Aug. 2, 2017 and entitled “Systems, Methods and Apparatuses of Platforms for Managing and Facilitating Transactions or Other User Activities Associated with Virtual or Digital Real-Estate,” (8002.US00), the contents of which are incorporated by reference in its entirety; and

U.S. Provisional Application No. 62/557,775, filed Sep. 13, 2017 and entitled “Systems and Methods of Augmented Reality Enabled Applications Including Social Activities or Web Activities and Apparatuses of Tools Therefor,” (8004.US00), the contents of which are incorporated by reference in its entirety.

### CROSS-REFERENCE TO RELATED APPLICATIONS

This application is related to PCT Application No. PCT/US18/44844, filed on Aug. 1, 2018 and entitled “Systems, Methods and Apparatuses to Facilitate Trade or Exchange of Virtual Real-Estate Associated With A Physical Space,” (8002.WO01), the contents of which are incorporated by reference in their entirety.

### TECHNICAL FIELD

The disclosed technology relates generally to augmented reality environments and value and demand for virtual spaces in the augmented reality environments by virtue of association with physical spaces.

### BACKGROUND

The advent of the World Wide Web and its proliferation in the 90's transformed the way humans conduct business, live lives, consume/communicate information and interact with or relate to others. A new wave of technology is on the cusp of the horizon to revolutionize our already digitally immersed lives.

### BRIEF DESCRIPTION OF THE DRAWINGS

FIG. 1 illustrates an example block diagram of a host server able to facilitate trade or exchange of virtual real-estate (VRE) associated with a physical space, in accordance with embodiments of the present disclosure.

FIG. 2A-2B depict illustrations showing examples of relative locations corresponding to people or movable physical things in the real world, in accordance with embodiments of the present disclosure.

FIG. 2C depicts an example diagram of a physical coordinate system generated for a physical location in the real world, in accordance with embodiments of the present disclosure.

FIG. 2D depicts an example diagram of another physical coordinate system generated for a physical location in the real world, in accordance with embodiments of the present disclosure.

FIG. 3A depicts an example functional block diagram of a host server that administers a marketplace to facilitate trade or exchange of virtual real-estate (VRE) associated with a physical place, in accordance with embodiments of the present disclosure.

FIG. 3B depicts an example block diagram illustrating the components of the host server that administers a marketplace to facilitate trade or exchange of virtual real-estate (VRE), in accordance with embodiments of the present disclosure

FIG. 4A depicts an example functional block diagram of a client device such as a mobile device that presents, to a human user, a marketplace to facilitate trade or exchange of virtual real-estate (VRE), that is associated with a physical location in the real world, in accordance with embodiments of the present disclosure

FIG. 4B depicts an example block diagram of the client device, which can be a mobile device that presents a marketplace to facilitate trade or exchange of virtual real-estate (VRE), in accordance with embodiments of the present disclosure.

FIG. 5A graphically depicts a view of an example grid of a physical coordinate system for locations corresponding to a surface of the Earth, shown in 2D, in accordance with embodiments of the present disclosure.

FIG. 5B graphically depicts examples of various shapes and dimensions of physical coordinate systems, in accordance with embodiments of the present disclosure.

FIG. 5C graphically depicts views of different angles and of the example grid of a physical coordinate system for locations corresponding to a surface of the Earth, in accordance with embodiments of the present disclosure.

FIG. 5D graphically depicts a view of an example grid of a physical coordinate system for locations in the universe, in accordance with embodiments of the present disclosure.

FIG. 6A depicts a flow chart illustrating an example process for to administer a marketplace for a virtual world component of an augmented reality environment, in accordance with embodiments of the present disclosure.

FIG. 6B depicts a flow chart illustrating an example process for managing and facilitating investments in virtual real-estate (VRE), in accordance with embodiments of the present disclosure.

FIG. 7 depicts a flow chart illustrating an example process to index a physical location in the real world, in accordance with embodiments of the present disclosure.

FIG. 8 depicts a flow chart illustrating an example process to facilitate trade or exchange of virtual real-estate (VRE), in accordance with embodiments of the present disclosure.

FIG. 9 is a block diagram illustrating an example of a software architecture that may be installed on a machine, in accordance with embodiments of the present disclosure.

FIG. 10 is a block diagram illustrating components of a machine, according to some example embodiments, able to read a set of instructions from a machine-readable medium (e.g., a machine-readable storage medium) and perform any one or more of the methodologies discussed herein.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

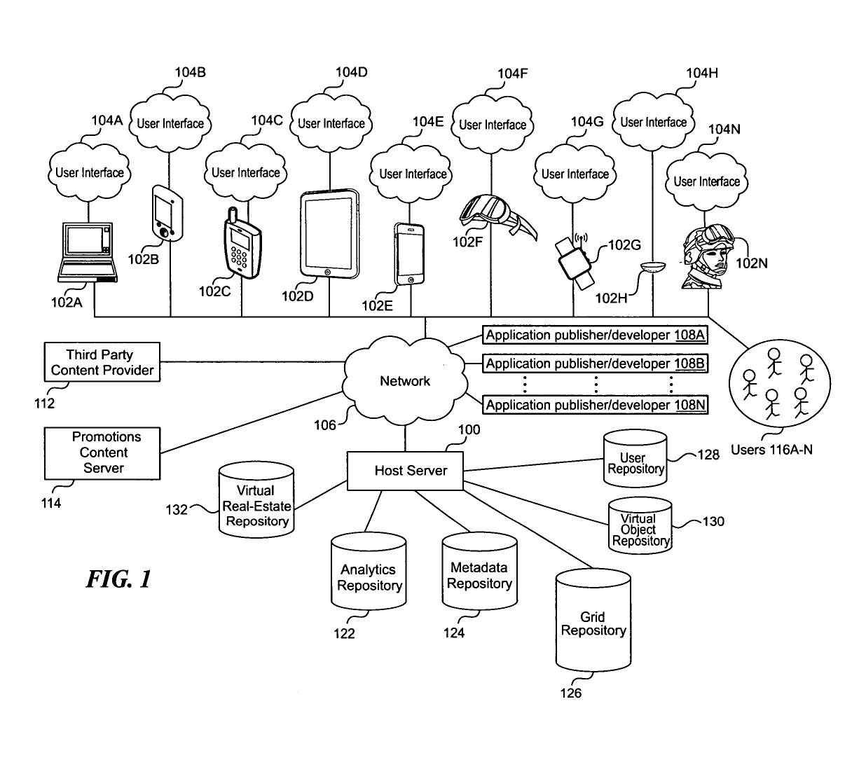

Embodiments of the present disclosure further include systems, methods and apparatuses of platforms (e.g., as hosted by the host server 100 as depicted in the example of FIG. 1) for managing and facilitating transactions or other activities associated with virtual real-estate (e.g., or digital real-estate). In general the, virtual or digital real-estate is associated with physical locations in the real world. The platform facilitates monetization and trading of a portion or portions of virtual spaces or virtual layers (e.g., virtual real-estate) of an augmented reality (AR) environment (e.g., alternate reality environment, mixed reality (MR) environment) or virtual reality VR environment.

In an augmented reality environment (AR environment), scenes or images of the physical world is depicted with a virtual world that appears to a human user, as being superimposed or overlaid of the physical world. Augmented reality enabled technology and devices can therefore facilitate and enable various types of activities with respect to and within virtual locations in the virtual world. Due to the inter connectivity and relationships between the physical world and the virtual world in the augmented reality environment, activities in the virtual world can drive traffic to the corresponding locations in the physical world. Similarly, content or virtual objects (VOBs) associated with busier physical locations or placed at certain locations (e.g., eye level versus other levels) will likely have a larger potential audience.

By virtual of the inter-relationship and connections between virtual spaces and real world locations enabled by or driven by AR, just as there is a value to real-estate in the real world locations, there can be inherent value or values for the corresponding virtual real-estate in the virtual spaces. For example, an entity who is a right holder (e.g., owner, renter, sub-lettor, licensor) or is otherwise associated a region of virtual real-estate can control what virtual objects can be placed into that virtual real-estate.

The entity that is the rightholder of the virtual real-state can control the content or objects (e.g., virtual objects) that can be placed in it, by whom, for how long, etc. As such, the disclosed technology includes a marketplace (e.g., as run by server 100 of FIG. 1) to facilitate exchange of virtual real-estate (VRE) such that entities can control object or content placement to a virtual space that is associated with a physical space.

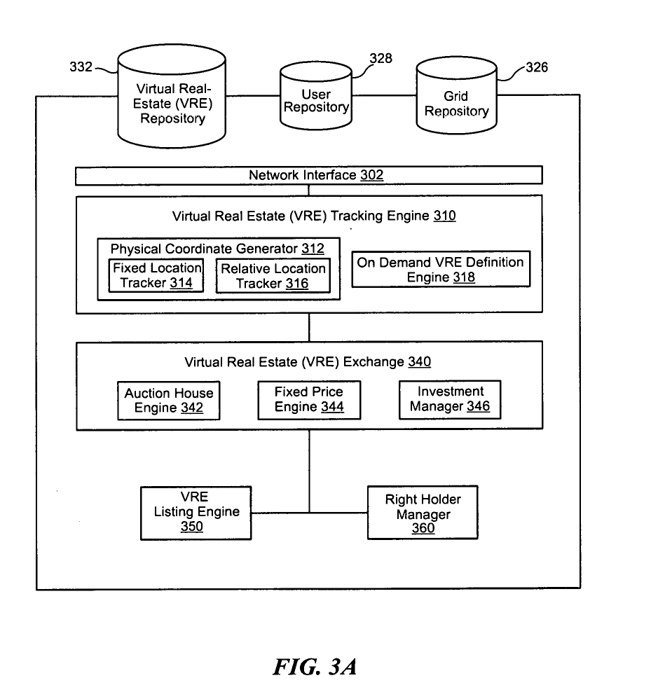

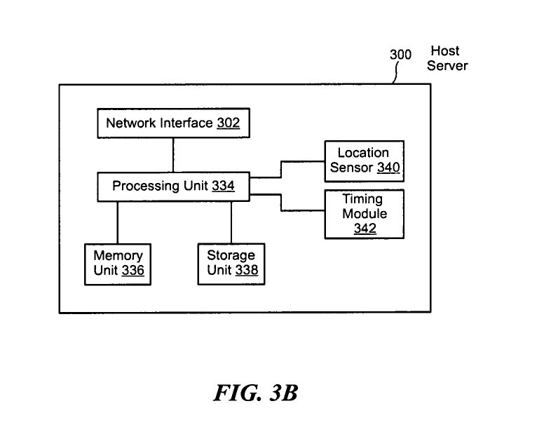

In one example, entities can buy attention by claiming or requesting rights to virtual real-estate (VRE) in a transaction, which can in on example, be carried out in an auction process. The winner of the auction or the entity that consummates the transaction can obtain a lease, license, sublease or sub-license from an initial rightholder which can be, either another entity or the disclosed platform (e.g., as hosted by server 100 of FIG. 1 or server 300 of FIG. 3) on the VRE for a period of time. When that time expires the VRE can for example, go back on action.

Note that a current rightholder (e.g., lease holder, licensee, renter, owner) can participate in any potential upside in price alongside the initial or previous right holder (e.g., the disclosed platform, any other entity). Therefore these plots of virtual real-estate are short term investments or long term investments, and can parallel patterns of human activity in the geographic landscape. High traffic city centers provide more potential attention and so the auction for virtual-estate in those areas will close at a higher prices than less busy areas.

The virtual real real-estate (VRE) can be, in one embodiment, bought and sold with a currency (e.g. digital currency or cryptocurrency) unique to the disclosed platform (e.g., as hosted by server 100 of FIG. 1 or server 300 of FIG. 3).

Entities can participate in VRE marketplace activity using fiat, cryptocurrency, designated currency or system-specific cryptocurrency or any other digital currency. As the disclosed VRE is parallel to physical locations that have known value, the VRE will derives at least some inherent value from that. The inherent value of the disclosed VRE will also have direct correlation with the amount of users of the disclosed platform (e.g., as hosted by server 100 of FIG. 1 or server 300 of FIG. 3).

Embodiments of the present disclosure further include systems, methods and apparatuses of seamless integration of augmented, alternate, virtual, and/or mixed realities with physical realities for enhancement of web, mobile and/or other digital experiences. Embodiments of the present disclosure further include systems, methods and apparatuses to facilitate physical and non-physical interaction/action/reactions between alternate realities. Embodiments of the present disclosure also systems, methods and apparatuses of multidimensional mapping of universal locations or location ranges for alternate or augmented digital experiences. Yet further embodiments of the present disclosure include systems, methods and apparatuses to create real world value and demand for virtual spaces via an alternate reality environment.

The disclosed platform enables and facilitates authoring, discovering, and/or interacting with virtual objects (VOBs). One example embodiment includes a system and a platform that can facilitate human interaction or engagement with virtual objects (hereinafter, ‘VOB,’ or ‘VOBs’) in a digital realm (e.g., an augmented reality environment (AR), an alternate reality environment (AR), a mixed reality environment (MR) or a virtual reality environment (VR)). The human interactions or engagements with VOBs in or via the disclosed environment can be integrated with and bring utility to every day lives through integration, enhancement or optimization of our digital activities such as web browsing, digital (online, or mobile shopping) shopping, socializing (e.g., social networking, sharing of digital content, maintaining photos, videos, other multimedia content), digital communications (e.g., messaging, emails, SMS, mobile communication channels, etc.), business activities (e.g., document management, document procession), business processes (e.g., IT, HR, security, etc.), transportation, travel, etc.

The disclosed innovation provides another dimension to digital activities through integration with the real world environment and real world contexts to enhance utility, usability, relevancy, and/or entertainment or vanity value through optimized contextual, social, spatial, temporal awareness and relevancy. In general, the virtual objects depicted via the disclosed system and platform. can be contextually (e.g., temporally, spatially, socially, user-specific, etc.) relevant and/or contextually aware. Specifically, the virtual objects can have attributes that are associated with or relevant real world places, real world events, humans, real world entities, real world things, real world objects, real world concepts and/or times of the physical world, and thus its deployment as an augmentation of a digital experience provides additional real life utility.

Note that in some instances, VOBs can be geographically, spatially and/or socially relevant and/or further possess real life utility. In accordance with embodiments of the present disclosure, VOBs can be or appear to be random in appearance or representation with little to no real world relation and have little to marginal utility in the real world. It is possible that the same VOB can appear random or of little use to one human user while being relevant in one or more ways to another user in the AR environment or platform.

The disclosed platform enables users to interact with VOBs and deployed environments using any device (e.g., devices 102A-N in the example of FIG. 1), including by way of example, computers, PDAs, phones, mobile phones, tablets, headmounted devices, goggles, smart watches, monocles, smart lens, smart watches and other smart apparel (e.g., smart shoes, smart clothing), and any other smart devices.

In one embodiment, the disclosed platform is a Web for the physical world. The host server (e.g., host server 100 as depicted in the example of FIG. 1) can provide a browser, a hosted server, and a search engine, for this new Web.

Embodiments of the disclosed platform enables content (e.g., VOBs, third party applications, AR-enabled applications, or other objects) to be created and placed into layers (e.g., components of the virtual world, namespaces, virtual world components, digital namespaces, etc.) that overlay geographic locations by anyone, and focused around a layer that has the highest number of audience (e.g., a public layer). The public layer can in some instances, be the main discovery mechanism and source for advertising venue for monetizing the disclosed platform.

In one embodiment, the disclosed platform includes a virtual world that exists in another dimension superimposed on the physical world. Users can perceive, observe, access, engage with or otherwise interact with this virtual world via a user interface (e.g., user interface 104A-N as depicted in the example of FIG. 1) of client application (e.g., accessed via using a user device, such as devices 102A-N as illustrated in the example of FIG. 1).

One embodiment of the present disclosure includes a consumer or client application component (e.g., as deployed on user devices, such as user devices 102A-N as depicted in the example of FIG. 1) which is able to provide geo-contextual awareness to human users of the AR environment and platform. The client application can sense, detect or recognize virtual objects and/or other human users, actors, non player characters or any other human or computer participants that are within range of their physical location, and can enable the users to observe, view, act, interact, react with respect to the VOBs.

Furthermore, embodiments of the present disclosure further include an enterprise application (which can be desktop, mobile or browser based application). In this case, retailers, advertisers, merchants or third party e-commerce platforms/sites/providers can access the disclosed platform through the enterprise application which enables management of paid advertising campaigns deployed via the platform.

Users (e.g., users 116A-N of FIG. 1) can access the client application which connects to the host platform (e.g., as hosted by the host server 100 as depicted in the example of FIG. 1). The client application enables users (e.g., users 116A-N of FIG. 1) to sense and interact with virtual objects (“VOBs”) and other users (“Users”), actors, non player characters, players, or other participants of the platform. The VOBs can be marked or tagged (by QR code, other bar codes, or image markers) for detection by the client application.

One example of an AR environment deployed by the host (e.g., the host server 100 as depicted in the example of FIG. 1) enables users to interact with virtual objects (VOBs) or applications related to shopping and retail in the physical world or online/e-commerce or mobile commerce. Retailers, merchants, commerce/e-commerce platforms, classified ad systems, and other advertisers will be able to pay to promote virtual objects representing coupons and gift cards in physical locations near or within their stores. Retailers can benefit because the disclosed platform provides a new way to get people into physical stores. For example, this can be a way to offer VOBs can are or function as coupons and gift cards that are available or valid at certain locations and times.

Additional environments that the platform can deploy, facilitate, or augment can include for example AR-enabled games, collaboration, public information, education, tourism, travel, dining, entertainment etc.

The seamless integration of real, augmented and virtual for physical places/locations in the universe is a differentiator. In addition to augmenting the world, the disclosed system also enables an open number of additional dimensions to be layered over it and, some of them exist in different spectra or astral planes. The digital dimensions can include virtual worlds that can appear different from the physical world. Note that any point in the physical world can index to layers of virtual worlds or virtual world components at that point. The platform can enable layers that allow non-physical interactions.

FIG. 1 illustrates an example block diagram of a host server 100 able to facilitate trade or exchange of virtual real-estate (‘VRE’) associated with a physical space, in accordance with embodiments of the present disclosure.

The client devices 102A-N can be any system and/or device, and/or any combination of devices/systems that is able to establish a connection with another device, a server and/or other systems. Client devices 102A-N each typically include a display and/or other output functionalities to present information and data exchanged between among the devices 102A-N and the host server 100.

For example, the client devices 102A-N can include mobile, hand held or portable devices or non-portable devices and can be any of, but not limited to, a server desktop, a desktop computer, a computer cluster, or portable devices including, a notebook, a laptop computer, a handheld computer, a palmtop computer, a mobile phone, a cell phone, a smart phone, a PDA, a Blackberry device, a Treo, a handheld tablet (e.g. an iPad, a Galaxy, Xoom Tablet, etc.), a tablet PC, a thin-client, a hand held console, a hand held gaming device or console, an iPhone, a wearable device, a head mounted device, a smart watch, a goggle, a smart glasses, a smart contact lens, and/or any other portable, mobile, hand held devices, etc. The input mechanism on client devices 102 can include touch screen keypad (including single touch, multi-touch, gesture sensing in 2D or 3D, etc.), a physical keypad, a mouse, a pointer, a track pad, motion detector (e.g., including 1-axis, 2-axis, 3-axis accelerometer, etc.), a light sensor, capacitance sensor, resistance sensor, temperature sensor, proximity sensor, a piezoelectric device, device orientation detector (e.g., electronic compass, tilt sensor, rotation sensor, gyroscope, accelerometer), eye tracking, eye detection, pupil tracking/detection, or a combination of the above.

The client devices 102A-N, application publisher/developer 108A-N, its respective networks of users, a third party content provider 112, and/or promotional content server 114, can be coupled to the network 106 and/or multiple networks. In some embodiments, the devices 102A-N and host server 100 may be directly connected to one another. The alternate, augmented provided or developed by the application publisher/developer 108A-N can include any digital, online, web-based and/or mobile based environments including enterprise applications, entertainment, games, social networking, e-commerce, search, browsing, discovery, messaging, chatting, and/or any other types of activities (e.g., network-enabled activities).

In one embodiment, the host server 100 is operable to facilitate trade or exchange of virtual real-estate alone or in combination with the application publisher/developer 108A-N.

As discussed further, the host server can 100 establish and run a marketplace to facilitate trade or exchange of VRE. The host server 100 can also provide augmentation of any digital, online, web-based and/or mobile based VRE exchanges developed or published by application publisher/developer 108A-N. Moreover, the host server can 100 provide all additional applications discussed herein or the host server 100 can provide augmentation of any digital, online, web-based and/or mobile based environments developed or published by application publisher/developer 108A-N to virtualize or for integration with a virtual, augmented, alternate or mixed reality environment which can have temporal, contextual or geographical relevance. Similarly, the host server 100 can also alone or in combination with with application publisher/developer 108A-N facilitate physical or non-physical interaction/action/reaction amongst different realities, for instance, through search, discovering, browsing, or otherwise navigating within a reality or across realities.

In a further embodiment, the host server 100 is operable to facilitate multidimensional mapping of universal locations or location ranges for augmented digital experiences. Through such multidimensional mapping, the host server 100 can create real world value or demand for virtual spaces via an alternate/augmented reality environment.

In one embodiment, the disclosed framework includes systems and processes for enhancing the web and its features with augmented reality. Example components of the framework can include:
Browser (mobile browser, mobile app, web browser, etc.)
Servers and namespaces the host (e.g., host server 100 can host the servers and namespaces. The content (e.g, VOBs, any other digital object), applications running on, with, or integrated with the disclosed platform can be created by others (e.g., third party content provider 112, promotions content server 114 and/or application publisher/developers 108A-N, etc.).
Advertising system (e.g., the host server 100 can run an advertisement/promotions engine through the platform and any or all deployed augmented reality, alternate reality, mixed reality or virtual reality environments)
Commerce (e.g., the host server 100 can facilitate transactions in the network deployed via any or all deployed augmented reality, alternate reality, mixed reality or virtual reality environments and receive a cut. A digital token or digital currency (e.g., crypto currency) specific to the platform hosted by the host server 100 can also be provided or made available to users.)
Search and discovery (e.g., the host server 100 can facilitate search, discovery or search in the network deployed via any or all deployed augmented reality, alternate reality, mixed reality or virtual reality environments)
Identities and relationships (e.g., the host server 100 can facilitate social activities, track identifies, manage, monitor, track and record activities and relationships between users 116A).

Functions and techniques performed by the host server 100 and the components therein are described in detail with further references to the examples of FIG. 3A-3B.

In general, network 106, over which the client devices 102A-N, the host server 100, and/or various application publisher/provider 108A-N, content server/provider 112, and/or promotional content server 114 communicate, may be a cellular network, a telephonic network, an open network, such as the Internet, or a private network, such as an intranet and/or the extranet, or any combination thereof. For example, the Internet can provide file transfer, remote log in, email, news, RSS, cloud-based services, instant messaging, visual voicemail, push mail, VoIP, and other services through any known or convenient protocol, such as, but is not limited to the TCP/IP protocol, Open System Interconnections (OSI), FTP, UPnP, iSCSI, NSF, ISDN, PDH, RS-232, SDH, SONET, etc.

The network 106 can be any collection of distinct networks operating wholly or partially in conjunction to provide connectivity to the client devices 102A-N and the host server 100 and may appear as one or more networks to the serviced systems and devices. In one embodiment, communications to and from the client devices 102A-N can be achieved by an open network, such as the Internet, or a private network, such as an intranet and/or the extranet. In one embodiment, communications can be achieved by a secure communications protocol, such as secure sockets layer (SSL), or transport layer security (TLS).

In addition, communications can be achieved via one or more networks, such as, but are not limited to, one or more of WiMax, a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), enabled with technologies such as, by way of example, Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G, 4G, 5G, IMT-Advanced, pre-4G, 3G LTE, 3GPP LTE, LTE Advanced, mobile WiMax, WiMax 2, WirelessMAN-Advanced networks, enhanced data rates for GSM evolution (EDGE), General packet radio service (GPRS), enhanced GPRS, iBurst, UMTS, HSPDA, HSUPA, HSPA, UMTS-TDD, 1×RTT, EV-DO, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

The host server 100 may include internally or be externally coupled to a user repository 128, a virtual object repository 130, a grid repository 126, a metadata repository 124, an analytics repository 122 and/or a virtual real-estate (VRE) repository 132. The repositories can store software, descriptive data, images, system information, drivers, and/or any other data item utilized by other components of the host server 100 and/or any other servers for operation. The repositories may be managed by a database management system (DBMS), for example but not limited to, Oracle, DB2, Microsoft Access, Microsoft SQL Server, PostgreSQL, MySQL, FileMaker, etc.

The repositories can be implemented via object-oriented technology and/or via text files, and can be managed by a distributed database management system, an object-oriented database management system (OODBMS) (e.g., ConceptBase, FastDB Main Memory Database Management System, JDOInstruments, ObjectDB, etc.), an object-relational database management system (ORDBMS) (e.g., Informix, OpenLink Virtuoso, VMDS, etc.), a file system, and/or any other convenient or known database management package.

In some embodiments, the host server 100 is able to generate, create and/or provide data to be stored in the user repository 128, the virtual object repository 130, the grid repository 126, the metadata repository 124, the analytics repository 122 and/or the VRE repository 132. The user repository 128 and/or analytics repository 120 can store user information, user profile information, demographics information, analytics, statistics regarding human users, user interaction, brands advertisers, virtual object (or ‘VOBs’), access of VOBs, usage statistics of VOBs, ROI of VOBs, etc.

The virtual object repository 130 can store virtual objects and any or all copies of virtual objects. The metadata repository 124 is able to store virtual object metadata of data fields, identification of VOB classes, virtual object ontologies, virtual object taxonomies, etc. One embodiment further includes the VRE repository 132 which can store information or metadata about units or parcels of VRE and their associated physical places or locations, The grid repository 126 can store grids or grid identifiers generated from physical coordinate systems used to define or specify physical location or space boundaries.

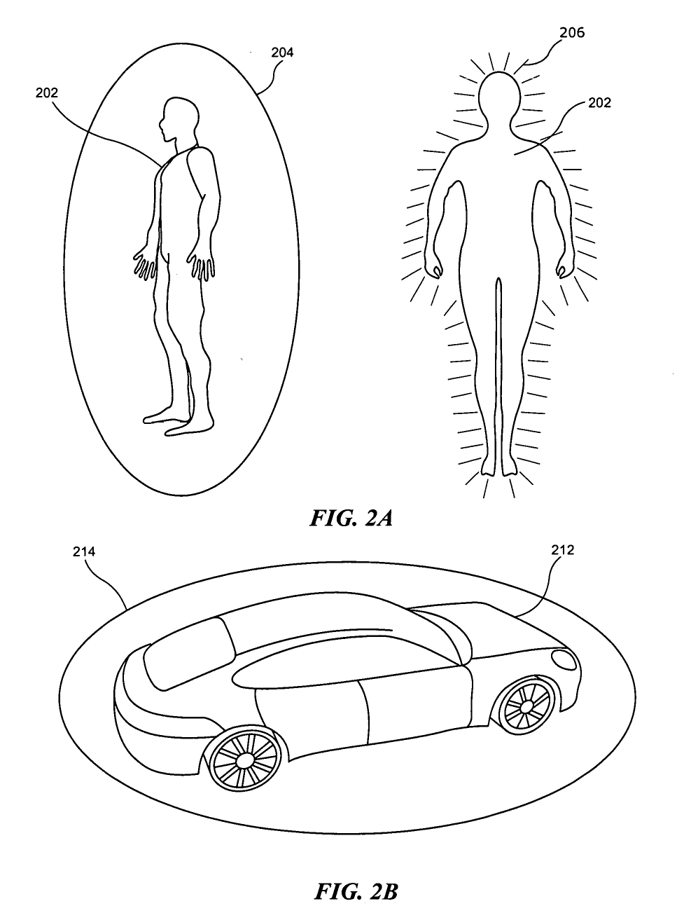

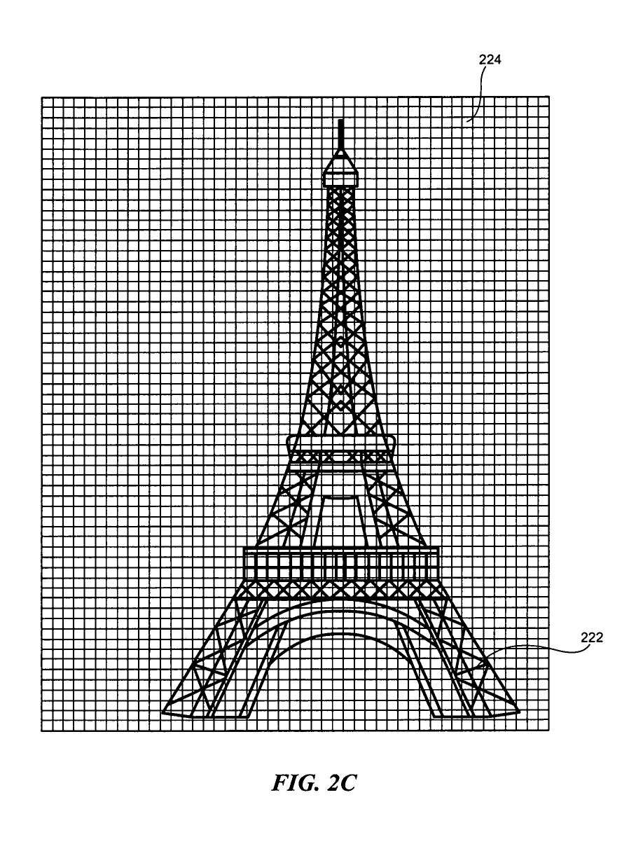

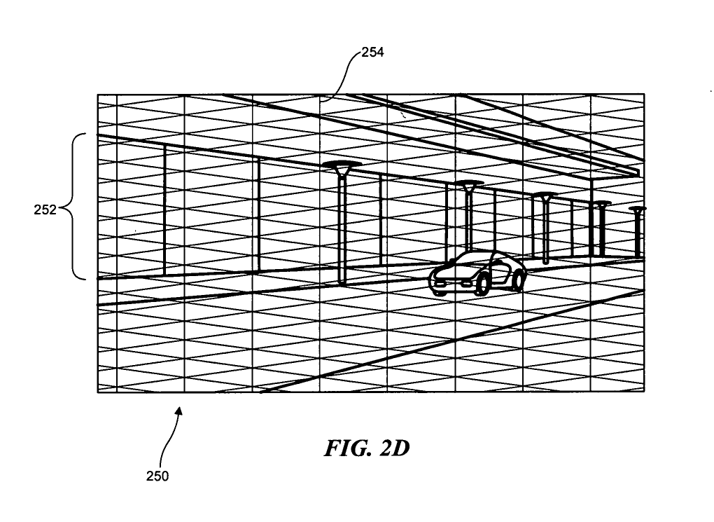

FIG. 2A-2B depict illustrations showing examples of relative locations corresponding to people 202 or movable physical things 212 in the real world, in accordance with embodiments of the present disclosure.

In embodiment of the present disclosure, the physical space 204 or physical region 206 in the real world physically surrounding, in the region of, or in the vicinity of (e.g., an area or space within a certain distance from) user 202 can be associated with user 202. For example, user 202 can be user Sue. As the physical space/region 204/206 are relative physical spaces defined with respected to the user Sue 202, the physical space/region 204/206 also move in space if and when the user 202 physically moves in any way or in any direction in the real world.

Note that a physical spaces or regions 204/206 relative to a human user's body can take on any shape (e.g., round, circle, oval, bubble, a plane, regular shape, irregular shape, etc.) or form or dimensions (e.g., 1d, 2d, 3d, 4d, etc.) or size (e.g., any area, any volume). The physical space/region 204/206 can also change or morph in shape, form or dimension based on system (e.g., host server 100 or 300) configuration or user specification (e.g., user 202), or other time, or based on a dynamic parameter.

The physical space 204 and/or physical region 206 around or relative to user Sue can be associated with virtual real estate units. According to embodiments of the present disclosure, Sue 202 can purchase, lease, sub-lease, license, sub-license virtual real-estate associated with physical space 204 or 206 around her own body to become rightholder, in accordance with the disclosure. In some embodiments, Sue can by default have control of or control of rights to the virtual space that is associated with some area or volume of space around her body. The physical space/region 204/206 can also be subdivided into multiple units or components. Units of the VRE associated with any subdivision of physical space/region 204/206 can be subject to trade or exchange, as disclosed.

Furthermore, another entity may purchase or lease any of the units of VRE associated with any portion of subdivision of the physical space 204 or 206 around Sue 202. Similarly, Sue can purchase or lease VRE unit(s) associated with physical space relative to or around another person's body.

Similarly, the physical space 214 in the real world physically around, in the region of or in the vicinity of vehicle 212 can be associated with the vehicle 212. The physical space 214 can be relative to the vehicle 212 such that the physical space 214 moves when the vehicle 212 moves and can be stationary when the vehicle is stationary. Note that a physical spaces or regions 204/206 relative to a human user's body can take on any shape (e.g., round, circle, oval, bubble, a plane, regular shape, irregular shape, etc.) or form or dimensions (e.g., 1d, 2d, 3d, 4d, etc.) or size (e.g., any area, any volume). The physical space 214.can also change in shape, form or dimension based on system (e.g., host server 100 or 300) configuration or user specification (e.g., user 202), or other time, or based on a dynamic or real time (near real time) parameter.

The physical space 214 associated with the vehicle 212 can be associated with one or more VRE units which can possess value and can be traded or exchanged between entities. For example, vehicle 212 can be a Porsche 911. Porsche company may wish to rent or lease the physical space 214 to publish Porsche related digital ads or information into the VRE units associated with the physical space 214. Similarly an investor or a competitive car maker may invest to become right holder of any or all units of VRE associated with the physical space 214 so that they can monetize such investment by anticipating selling, renting, leasing, subleasing, or licensing any or all such VRE units associated with the physical space 214 around the Porsche vehicle 212 to Porsche company.

FIG. 2C depicts an example diagram of a physical coordinate system 224 generated for a physical location 222 in the real world, in accordance with embodiments of the present disclosure.

The physical location 222 (e.g., the Eiffel tower in Paris) can be associated with the physical coordinate system 224. The physical coordinate system 224 can for example, be represented as the depicted grid. Using the physical coordinate system 224, various physical places in and around the Eiffel tower 222 and its vicinity can be identified and defined with boundaries specified using the grids of the physical coordinate system 224. A unit or parcel of VRE can then be assigned to or associated with a unit of physical space among the physical places. Note that although the grid is illustrated as being a 2D square/rectangular grid system, it is noted that without deviating from the novel art of the disclosure, a grid representing the physical coordinate system 224 can take on any shape or form having any number of sides or angles (e.g., triangle, circular, oval, any quadrilateral, rectangular, pentagonal, hexagonal, etc.) or be any irregular shape or form of any number of dimensions (e.g., 1d, 2d, 3d, 4d, etc.).

FIG. 2D depicts an example diagram of another physical coordinate system 254 generated for a physical location 250 in the real world, in accordance with embodiments of the present disclosure.

For example, physical place 252 can be a storefront facade along a street in the physical location 250 in the real world. The physical coordinate system 254 as illustrated by the grid 254 can be used to specify or define the boundaries of physical places in the location 250. Units of virtual real-estate (VRE) can then be assigned to parts, components or units of physical spaces defined by the boundaries in the physical location 250. The physical coordinate system 254 can also be used to define a physical space around or in a vicinity of the vehicle in physical location 250. As the vehicle moves, the physical space moves around with the vehicle. Such moving physical space can also be assigned one or more units of VRE that can be traded or exchanged in the disclosed marketplace.

Note that although the grid is illustrated as being a 2D square/rectangular grid system, it is noted that without deviating from the novel art of the disclosure, a grid representing the physical coordinate system 254 can take on any shape or form having any number of sides or angles (e.g., triangle, circular, oval, any quadrilateral, rectangular, pentagonal, hexagonal, etc.) or be any irregular shape or form of any number of dimensions (e.g., 1d, 2d, 3d, 4d, etc.).

FIG. 3A depicts an example functional block diagram of a host server 300 that administers a marketplace to facilitate trade or exchange of virtual real-estate (VRE) associated with a physical place, in accordance with embodiments of the present disclosure.

The host server 300 includes a network interface 302, a virtual real-estate (VRE) tracking engine 310, a virtual real estate (VRE) exchange 340, a virtual real-estate (VRE) listing engine 350, and/or a right holder manager 360. The host server 300 is also coupled to a user repository 328, a virtual real-estate (VRE) repository 332 and/or a grid repository 326. Each of the virtual real-estate (VRE) tracking engine 310, the virtual real estate (VRE) exchange 340, the virtual real-estate (VRE) listing engine 350, and/or the right holder manager 360. can be coupled to each other.

One embodiment of the VRE engine 310 includes, a physical coordinate generator 312 having a fixed location tracker 314 and/or a relative location tracker 316, and an on-demand VRE definition engine 318. One embodiment of the VRE exchange 340 includes, an auction house engine 342, a fixed price engine 344 and/or an investment manager 346.

Additional or less modules can be included without deviating from the techniques discussed in this disclosure. In addition, each module in the example of FIG. 3A can include any number and combination of sub-modules, and systems, implemented with any combination of hardware and/or software modules.

The host server 300, although illustrated as comprised of distributed components (physically distributed and/or functionally distributed), could be implemented as a collective element. In some embodiments, some or all of the modules, and/or the functions represented by each of the modules can be combined in any convenient or known manner. Furthermore, the functions represented by the modules can be implemented individually or in any combination thereof, partially or wholly, in hardware, software, or a combination of hardware and software.

The network interface 302 can be a networking module that enables the host server 300 to mediate data in a network with an entity that is external to the host server 300, through any known and/or convenient communications protocol supported by the host and the external entity. The network interface 302 can include one or more of a network adaptor card, a wireless network interface card (e.g., SMS interface, WiFi interface, interfaces for various generations of mobile communication standards including but not limited to 1G, 2G, 3G, 3.5G, 4G, LTE, 5G, etc.,), Bluetooth, a router, an access point, a wireless router, a switch, a multilayer switch, a protocol converter, a gateway, a bridge, bridge router, a hub, a digital media receiver, and/or a repeater.

As used herein, a “module,” a “manager,” an “agent,” a “tracker,” a “handler,” a “detector,” an “interface,” or an “engine” includes a general purpose, dedicated or shared processor and, typically, firmware or software modules that are executed by the processor. Depending upon implementation-specific or other considerations, the module, manager, tracker, agent, handler, or engine can be centralized or have its functionality distributed in part or in full. The module, manager, tracker, agent, handler, or engine can include general or special purpose hardware, firmware, or software embodied in a computer-readable (storage) medium for execution by the processor.

As used herein, a computer-readable medium or computer-readable storage medium is intended to include all mediums that are statutory (e.g., in the United States, under 35 U.S.C. 101), and to specifically exclude all mediums that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, flash, optical storage, to name a few), but may or may not be limited to hardware.

One embodiment of the host server 300 includes the virtual real-estate (VRE) tracking engine 310 having the physical coordinate generator 312 having the fixed location tracker 314 and/or the relative location tracker 316, and the on-demand VRE definition engine 318. The VRE tracking engine 310 can be any combination of software agents and/or hardware modules (e.g., including processors and/or memory units) able to create, provision, allocate, administer, generate, manage, govern, track, update, define, VRE, VRE parcels, or units of VRE that are associated with physical locations in the real world. The VRE tracking engine 310 can also assign, correspond and/or associate units of VRE to units of physical space/physical locations in the real world and/or track, revise, update and modify its association, definition and assignment.

In general, virtual real-estate (e.g., digital real-estate, virtual world, virtual world component, virtual space, layer or virtual layer, etc.) is or is a part of the virtual world of an augmented reality (AR) environment (e.g., or alternate reality environment, virtual environment (VR), mixed reality (MR) environment, etc.). In the augmented reality environment the virtual world can be rendered or depicted to a human user (e.g., via a digital representation observed via a user device) and appear to be overlaid over a representation of the physical environment in the real world, as observed by the human user. As such, just as there is a value to real-estate in the physical space, there can be a value or values for the corresponding virtual real-estate in the virtual space that corresponds to the real physical space. In general, the AR environment and AR-enabled technology can facilitate, enable or enhance digital through contextual relevance and awareness.

Content or other digital objects (e.g., virtual objects or VOBs) that are posted, published, put in, or otherwise associated with the virtual real estate or a given parcel or unit of the VRE can be depicted in or around the associated physical location. The content or other digital objects can then be made available for access, viewing, consumption or interaction with when the target or intended audience (e.g., entities or human users) is in or near, or otherwise associated with the physical location.

In embodiments of the present disclosure, the VRE tracking engine 310 can generate, create, specify, or define a physical coordinate system (e.g., by the physical coordinate generator 312). The physical coordinate system can be defined by indexing locations in a physical space. Locations in a physical space can be fixed (e.g. landmarks, lakes, parks, cities, streets, White house, Rockefeller center, a Chipotle's store, etc, illustrated in the example the Eiffel tower of FIG. 2C) and can be identified, tracked, indexed by the fixed location tracker 314.

For example, for fixed locations in the real physical world, such as locations in a downtown area or in front of stores, or anywhere else in the physical world, there is corresponding virtual real-estate that can be traded, exchanged, managed and/or monetized according to the policies set or configured by the server 300 and/or the owner, renter or other rightholder of the VRE unit.

In addition, relative locations in the physical space can also be movable, for example, physical spaces around persons (e.g., as shown in the examples of FIG. 2A) and/or spaces around physical thing or object that is movable, in motion or stationary (e.g., as illustrated in the example of FIG. 2B). Relative locations can be identified, tracked, indexed by the relative location tracker 316.

For instance, around people and physical things/objects there can be some local virtual real-estate that is relative to them and moves wherever they go. For example there can be a bubble of virtual real-estate of a certain size (dynamic of fixed size) around each person (e.g., as illustrated in the examples of FIG. 2A-FIG. 2B), and around physical objects (things, products, etc). The locations in that bubble of virtual real-estate can be traded, exchanged, managed and/or monetized according to policies set by software and/or the owner of the virtual real-estate

Using the indices defined or generated for the physical location, the physical coordinate generator 312 can define or generate the physical coordinate system for the physical place. Using the physical coordinate system, units or parcels of VRE associated with units of the physical location. In general, VRE or units of VRE can be represented in one dimension, two dimensions, three dimensions or n-dimensions. Moreover, for a given physical location in a physical space, there can be one or more corresponding virtual locations. In essence, this the mappings between units or parcels of VRE and units of a physical location can be a one to one relationship, one to may, or many to many relationship.

Note that physical coordinate systems can also in some instances be defined or specified by third parties, vendors, entities or organizations. A right holder of a corresponding digital/virtual real-estate can also define, modify, redefine a physical coordinate system for the associated physical space/location.

The on-demand VRE definition engine 318 enables entities (e.g., third party entities, organizations, humans, bots, robots and/or companies) to specify, define or customize boundaries of a VRE unit, plot or parcel. For example, an entity can choose any region of virtual real-estate corresponding to a region of the physical world, and request to purchase, rent or acquire the region of VRE, If the region of VRE has a current rightholder, a request can be placed to the rightholder to purchase, lease, sublease or license the region of VRE. If the region has no current rightholder (e.g., not owned, rented, or licensed by another entity), the server 300 can the facilitate trade or exchange of the region (e.g., by the VRE exchange 340).

Alternatively, the engine 318 can also enable entities to specify, define or customize boundaries of a physical location using a physical coordinate system, The unit of VRE which corresponds to the physical location defined can then be put in the market for trade or exchange (as administered by the VR Exchange 340). This can allow for irregular shapes of virtual real-estate units or parcels to be defined and traded. An entity can buy the virtual real-estate unit(s) associated with all of Manhattan if desired. An entity can also buy a shape of virtual real-estate the corresponds the irregular shape of the boundary of a place in the physical world such as a college campus (e.g., Columbia University) or a public park (e.g., Central Park).

One embodiment of the host server 300 includes the VRE exchange 340 having the auction house engine 324, the fixed price engine 344 and/or the investment manager 346. The VRE exchange 340 can be any combination of software agents and/or hardware modules (e.g., including processors and/or memory units) able to provide, deploy or administer a marketplace for a virtual world component (e.g., unit or parcel of VRE) of an augmented reality environment. The marketplace can facilitate sale, lease, rent, licensing or any other form of trade, exchange, bartering for change of control and/or ownership of VRE units or parcel.

Responsive to a request to carry out a transaction of a VRE unit or parcel (or virtual world component) a listing for the VRE unit or parcel can be generated and presented/pushed to potential offerors (e.g., potential buyers, renters, sublets, licensors and the like.). The request can be triggered by a current right holder, or an entity interested in the unit or parcel of VRE. In addition, the VRE exchange 340 can anticipate or determine when the term of the prior ownership or lease ends and initiate a transaction.

The potential offerors can human users, companies, organizations or any other entity. The potential offerors can be identified using, a list of registered entities, transaction history of various entities with respect to VRE units, based on user location or user location statistics. For example, the server 300 can determine that users that are frequently physically in or around a physical location which corresponds to the VRE unit are likely potential offerors. The server 300 can also identify potential offerors based on attributes of the physical location with which the VRE unit is associated. For example, whether the physical location is a landmark, a business premise, an office, located in a large city, on a farm, a private residence, etc.

The listing of the VRE unit or parcel depicted can include a manifest of the VRE unit. The manifest can include parameters specifying details of the physical space with which the VRE unit is associated. The manifest can also include parameters to specify any or all terms which underpin the transaction of the VRE unit or parcel. Additional customized parameters (e.g., customized by third parties) can also be included with the listing.

The VRE exchange can carry out the transaction for the VRE unit. For example, an auction or a bidding process can be initiated for the VRE unit or parcel (e.g., by the auction house engine 342). If an entity wins the auction (by submitting the highest bid(s)) and/or meet other specified criteria, the entity can be assigned (e.g., by the right holder manager 360) the rightholder of the VRE unit. Note that potential offerors can bid on the VRE unit/parcel or any subdivision of it.

The rightholder can be an owner, tenant, sub-lettor, licensee or sublicensee of the VRE unit. The VRE exchange 340 can also set a fixed price (e.g., via the fixed price engine 344) for the transaction of the VRE unit or parcel. The fixed price can be determined by the exchange 340 (e.g., based on market conditions or real time supply and demand), the fixed price can also be determined based on preferences or requirements of the present rightholder. In the fixed price scenario, potential offerors can also submit offers for any subdivision of the VRE unit/parcel.

One embodiment of the host server 300 includes the investment manager 346. The investment manager can be any combination of software agents and/or hardware modules (e.g., including processors and/or memory units) able to administer, manage, or track VRE investment by way of right-holding (owning, renting, subletting, licensing). The investment manager 346 can also compute or determine any gains for an entity with respect to their right-holding terms, and distribute such gains.

For example, a given right holder can be given some percentage of any increased price paid when a new lease is signed for the virtual real-estate or when the VRE is resold. For example, if an entity invests to lease virtual real-estate and the value increases when the lease expires, the entity can renew and keep it, or if someone else wins the auction to lease it then they can get a revenue share (in some currency or points system) of the new higher price. In this manner virtual real-estate can be a form of investment for buyers and for renters of that virtual real-estate: If the value increases the right-holder benefit from the increase in value. The investment manager 346 can also calculate any gains to a given right holder if VRE owned or rented becomes divided up and sold to, leased to, or licensed to a subsequent right holder(s) in subdivisions.

One embodiment of the host server 300 includes the right holder manager 360. The right holder manager 360 can be any combination of software agents and/or hardware modules (e.g., including processors and/or memory units) able to identify, determine, track, update, right holders of VRE units/parcels.

For example, if Sue wins the auction for a particular cube or set of cubes of real-estate in front a particular Starbucks store location in New York City, that is her virtual land and she has control of what virtual objects can be placed in it, by whom, for how long, etc, until and unless it goes back up for sale or rent. During the term in which she is in control of this virtual real-estate, she temporarily is the admin and/or gatekeeper and/or market maker and/or broker of this virtual real-estate

During the term of her ownership or lease, Sue can optionally sell the right to other parties to put virtual objects in that location for particular terms. So for example Sue could buy up the virtual real-estate in front of a particular Starbucks storefront. Then she can put her own virtual objects there, and/or she can sell the right to other parties, such as advertisers, or other people, to put virtual objects on her virtual real-estate.

The owner or lessor of a piece of virtual real-estate can sell their virtual real-estate or they may be able to lease it out, or sub-lease or license to other entities. Note that the owner of the virtual real-estate may or may not be the same entity as the owner of the physical real-estate to which it corresponds. For example Joe may own a certain physical building in a certain city, where Sue could buy up, own or manage the virtual real-estate corresponding to Joe's building if she meets certain predetermined, configured or dynamic criteria (e.g. financial or other) or if she wins the auction for it. Depending on policies of particular software applications, Sue can acquire, retain or buy permanent rights to the virtual real-estate or she might only own it temporarily via some criteria-limited e.g., time-limited set of terms (such as a lease or ownership that expires eventually). Sue and Joe, and other entities, for example, could compete via an auction to control all or some of the virtual real-estate corresponding to the physical real-estate in and around Joe's physical building location.

FIG. 3B depicts an example block diagram illustrating the components of the host server 300 that administers a marketplace to facilitate trade or exchange of virtual real-estate (VRE), in accordance with embodiments of the present disclosure.

In one embodiment, host server 300 includes a network interface 302, a processing unit 334, a memory unit 336, a storage unit 338, a location sensor 340, and/or a timing module 342. Additional or less units or modules may be included. The host server 300 can be any combination of hardware components and/or software agents for to facilitate trade or exchange of virtual real-estate associated with a physical space. The network interface 302 has been described in the example of FIG. 3A.

One embodiment of the host server 300 includes a processing unit 334. The data received from the network interface 302, location sensor 340, and/or the timing module 342 can be input to a processing unit 334. The location sensor 340 can include GPS receivers, RF transceiver, an optical rangefinder, etc. The timing module 342 can include an internal clock, a connection to a time server (via NTP), an atomic clock, a GPS master clock, etc.

The processing unit 334 can include one or more processors, CPUs, microcontrollers, FPGAs, ASICs, DSPs, or any combination of the above. Data that is input to the host server 300 can be processed by the processing unit 334 and output to a display and/or output via a wired or wireless connection to an external device, such as a mobile phone, a portable device, a host or server computer by way of a communications component.

One embodiment of the host server 300 includes a memory unit 336 and a storage unit 338. The memory unit 335 and a storage unit 338 are, in some embodiments, coupled to the processing unit 334. The memory unit can include volatile and/or non-volatile memory. In administering a marketplace for virtual real-estate units or parcels, the processing unit 334 may perform one or more processes related to facilitation of trade, exchange of VRE units and/or indexing physical locations in the real world.

In some embodiments, any portion of or all of the functions described of the various example modules in the host server 300 of the example of FIG. 3A can be performed by the processing unit 334.

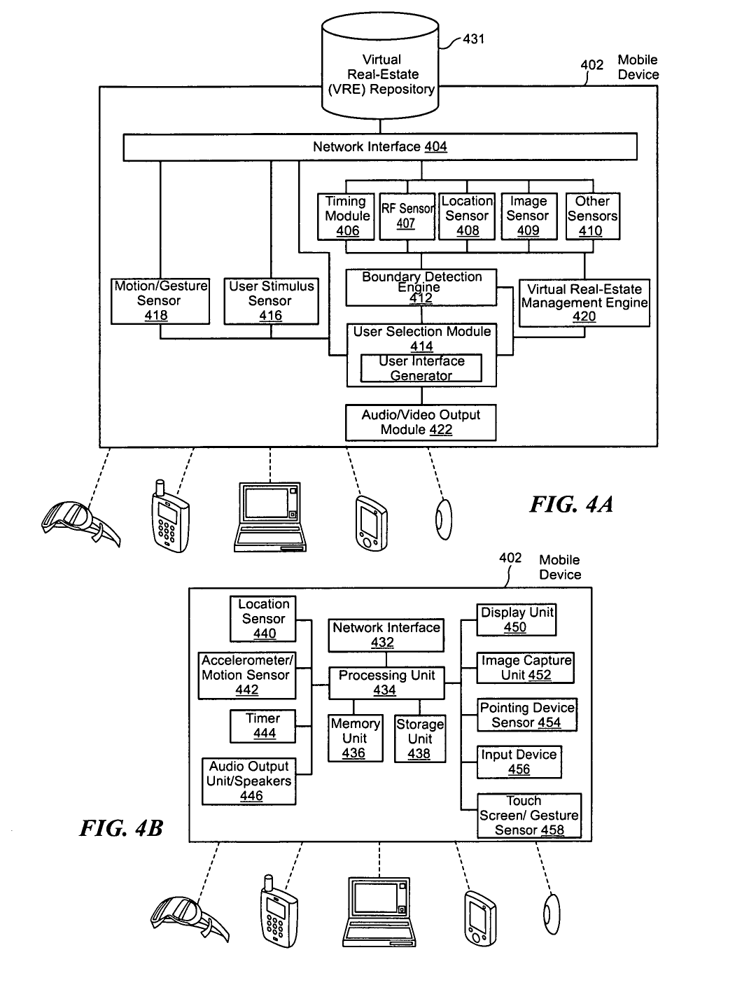

FIG. 4A depicts an example functional block diagram of a client device 402 such as a mobile device that presents, to a human user, a marketplace to facilitate trade or exchange of virtual real-estate (VRE), that is associated with a physical location in the real world, in accordance with embodiments of the present disclosure.

The client device 402 includes a network interface 404, a timing module 406, an RF sensor 407, a location sensor 408, an image sensor 409, a boundary detection engine 412, a user selection module 414, a user stimulus sensor 416, a motion/gesture sensor 418, a virtual real-estate (VRE) management engine 420, an audio/video output module 422, and/or other sensors 410. The client device 402 maybe any electronic device such as the devices described in conjunction with the client devices 102A-N in the example of FIG. 1 including but not limited to portable devices, a computer, a server, location-aware devices, mobile phones, PDAs, laptops, palmtops, iPhones, cover headsets, heads-up displays, helmet mounted display, head-mounted display, scanned-beam display, smart lens, monocles, smart glasses/goggles, wearable computer such as mobile enabled watches or eyewear, and/or any other mobile interfaces and viewing devices, etc.

In one embodiment, the client device 402 is coupled to a virtual real-estate (VRE) repository 431. The VRE repository 431 may be internal to or coupled to the mobile device 402 but the contents stored therein can be illustrated with reference to the example of the VRE repository 132 described in the example of FIG. 1.

Additional or less modules can be included without deviating from the novel art of this disclosure. In addition, each module in the example of FIG. 4A can include any number and combination of sub-modules, and systems, implemented with any combination of hardware and/or software modules.

The client device 402, although illustrated as comprised of distributed components (physically distributed and/or functionally distributed), could be implemented as a collective element. In some embodiments, some or all of the modules, and/or the functions represented by each of the modules can be combined in any convenient or known manner. Furthermore, the functions represented by the modules can be implemented individually or in any combination thereof, partially or wholly, in hardware, software, or a combination of hardware and software.

In the example of FIG. 4A, the network interface 404 can be a networking device that enables the client device 402 to mediate data in a network with an entity that is external to the host server, through any known and/or convenient communications protocol supported by the host and the external entity. The network interface 404 can include one or more of a network adapter card, a wireless network interface card, a router, an access point, a wireless router, a switch, a multilayer switch, a protocol converter, a gateway, a bridge, bridge router, a hub, a digital media receiver, and/or a repeater.

According to the embodiments disclosed herein, the client device 402 can render or present a marketplace to facilitate transactions of VRE units or parcels to be conducted.

The marketplace can also be rendered at least in part via one or more of, a mobile browser, a mobile application and a web browser, e.g., via the client device 402. Note that the marketplace environment can be rendered in part of in whole in a hologram, for example, in 3D and in 360 degrees, via the client device 402.

The client device 402 can provide functionalities described herein via a consumer client application (app) (e.g., consumer app, client app. Etc.), The consumer application includes a user interface that enables entities to view, access, interact with the marketplace, or to place bids, express interest, view VRE listings and listing details or parameters, make offers with respect to VRE units or parcels, specify boundaries of a physical space for which any corresponding VRE Units are of interest, etc. The client application can include a mobile application. The client app can also include a desktop client and/or web client.

Embodiments of the present disclosure includes the VRE management engine 420 which track, detects, identifies units or parcels of VRE associated with any given physical location. Embodiments of the present disclosure includes the boundary detection engine 412 which allows entities to select or specify boundaries of a region of physical space in a physical location.

FIG. 4B depicts an example block diagram of the client device 402, which can be a mobile device that presents a marketplace to facilitate trade or exchange of virtual real-estate (VRE), in accordance with embodiments of the present disclosure.

In one embodiment, client device 402 (e.g., a user device) includes a network interface 432, a processing unit 434, a memory unit 436, a storage unit 438, a location sensor 440, an accelerometer/motion sensor 442, an audio output unit/speakers 446, a display unit 450, an image capture unit 452, a pointing device/sensor 454, an input device 456, and/or a touch screen sensor 458. Additional or less units or modules may be included. The client device 402 can be any combination of hardware components and/or software agents for presenting, to a human user, mixed realities integrated with physical reality for enhancement of digital experiences. The network interface 432 has been described in the example of FIG. 4A.

One embodiment of the client device 402 further includes a processing unit 434. The location sensor 440, accelerometer/motion sensor 442, and timer 444 have been described with reference to the example of FIG. 4A.

The processing unit 434 can include one or more processors, CPUs, microcontrollers, FPGAs, ASICs, DSPs, or any combination of the above. Data that is input to the client device 402 for example, via the image capture unit 452, pointing device/sensor 554, input device 456 (e.g., keyboard), and/or the touch screen sensor 458 can be processed by the processing unit 434 and output to the display unit 450, audio output unit/speakers 446 and/or output via a wired or wireless connection to an external device, such as a host or server computer that generates and controls access to simulated objects by way of a communications component.

One embodiment of the client device 402 further includes a memory unit 436 and a storage unit 438. The memory unit 436 and a storage unit 438 are, in some embodiments, coupled to the processing unit 434. The memory unit can include volatile and/or non-volatile memory. In rendering or presenting an augmented reality environment, the processing unit 434 can perform one or more processes related to enhancement of digital experiences through facilitating physical and/or non-physical interaction/actions between alternate realities.

In some embodiments, any portion of or all of the functions described of the various example modules in the client device 402 of the example of FIG. 4A can be performed by the processing unit 434. In particular, with reference to the mobile device illustrated in FIG. 4A, various sensors and/or modules can be performed via any of the combinations of modules in the control subsystem that are not illustrated, including, but not limited to, the processing unit 434 and/or the memory unit 436.

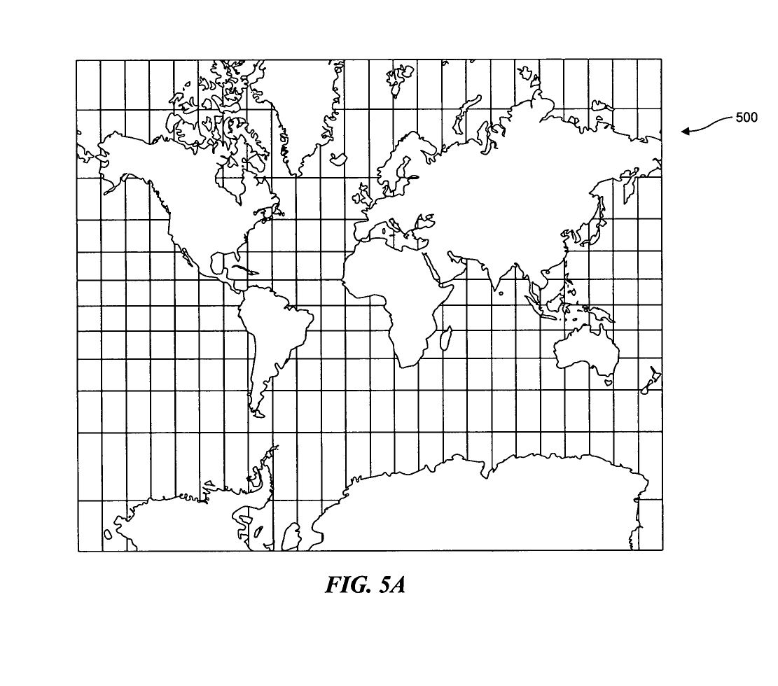

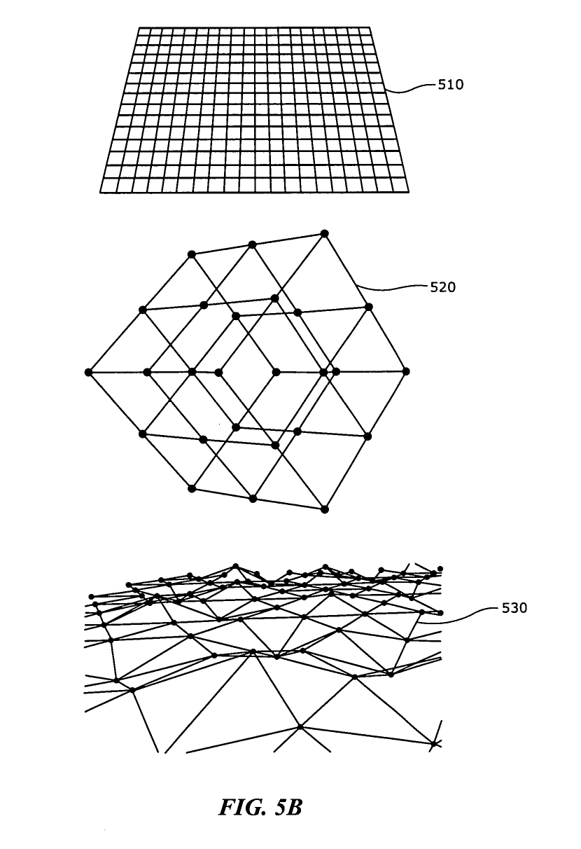

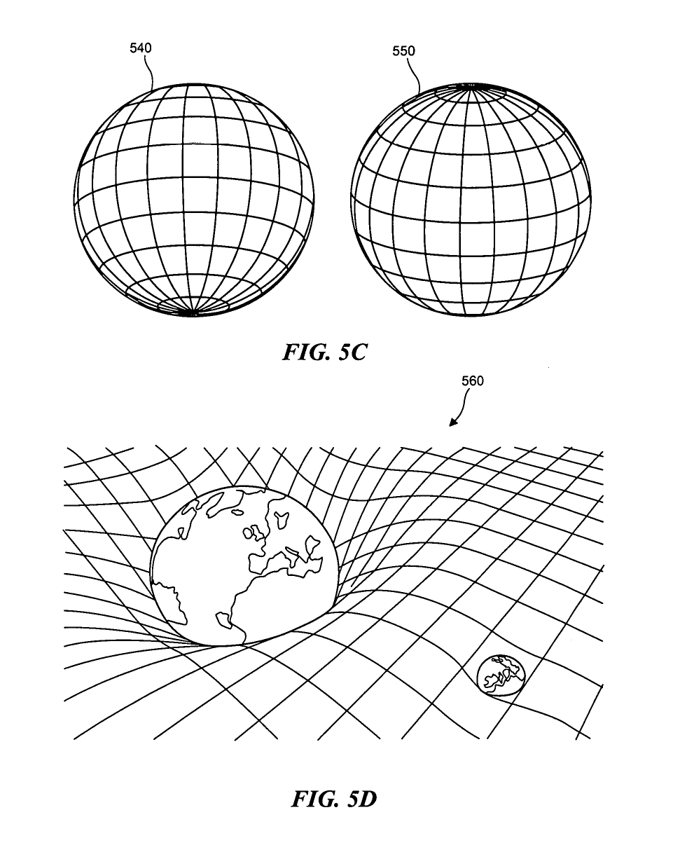

FIG. 5A graphically depicts a view 500 of an example grid of a physical coordinate system for locations corresponding to a surface of the Earth, shown in 2D, in accordance with embodiments of the present disclosure. FIG. 5B graphically depicts examples of various shapes and dimensions of physical coordinate systems, in accordance with embodiments of the present disclosure. FIG. 5C graphically depicts views of different angles 540 and 550 of the example grid of a physical coordinate system for locations corresponding to a surface of the Earth, in accordance with embodiments of the present disclosure.

The locations corresponding to the surface of the Earth can be identified or specified by, one or more of, longitude, latitude, latitude, x-axis, y-axis, z-axis, or names of locations, cities, states, countries, municipalities, land or property, one or more addresses. Various locations corresponding to the Earth's surface (some of these locations are continents and are depicted in FIG. 5A) can be indexed such generate any part of the physical coordinate system depicted by the grid.

Using the grid, boundaries for physical places within with locations can be created or defined using the coordinate system. Examples of a physical place in a location (e.g., fixed locations) can include, a city in state or country, a specific block in a city, a park in the city, a specific tree in a park, a landmark in a city, etc. A physical place can be a relative physical place such as the space or physical region around a user or a physical object which is movable, the boundaries of which can also be specified or defined using the physical coordinate system (e.g. a relative coordinate system). The physical coordinate system can be used to define either fixed or relative locations.

Physical places in a location can also be specified or defined on demand. For example, the grid can be used to define (e.g., on-demand) a specific peak in a mountain, a portion of a desktop in an office space, a specific portion of a store front (e.g., a door, a window, a subset of windows, etc.), etc.

Note that the view 500 depicts the grid in two dimensions. The grid can have three or more dimensions. For example, the grid can take on a third dimension that is perpendicular to the Earth's surface, as shown in the 3D grid 520. The grid can have two dimensions as shown in grid 510 which is primarily comprised of square or rectangular shapes.

Further note that although the shape of form of the grid is illustrated to be in a substantially square or rectangular form in view 500, the grid can take on any other shape including but not limited to, triangular, round, circular, spherical, oval, quadrilateral, pentagonal, hexagonal, octagonal or any other shape having any number of edges and angles of any number of dimensions. The grid can also take on any irregular shape. Furthermore, a given grid defined using the physical coordinate system can be comprised of sections of different shapes. For example, parts of the grid can take on a triangular form and parts of the grid can take on square or quadrilateral forms. Grid 530 depicts an example of a grid taking on triangular or pyramid forms.

Note that the grid can also take on any size (surface area and/or volume). The grid can also comprise of units of different sizes. For example, a denser or busier area (area with more physical things, physical objects, more people, more densely populated areas, metropolitan areas, big cities, office buildings, town squares, etc.) may have a finer grid (e.g., grids having smaller area or volume components) than a less dense or less busy area (e.g. the ocean, a farm, rural area, etc.).

FIG. 5D graphically depicts a view 560 of an example grid of a physical coordinate system for locations in the universe, in accordance with embodiments of the present disclosure.

Similarly, the physical coordinate system can be used to define or specify any fixed or relative locations in the universe. Although in the view 500, the grid takes on quadrilateral shapes, the grid of the physical coordinate system can take on any shape having any number of sides or angles, any irregular shape and have any number of dimensions (e.g., 1d, 2d, 3d, etc.). The grids can comprise of components of any sized (e.g. area or volume) grid components. A given grid can be comprised of substantially similar sized grid components or be comprised of grid components of varying sizes. A given grid can also have parts of grids of varying shapes, forms, and dimensions.

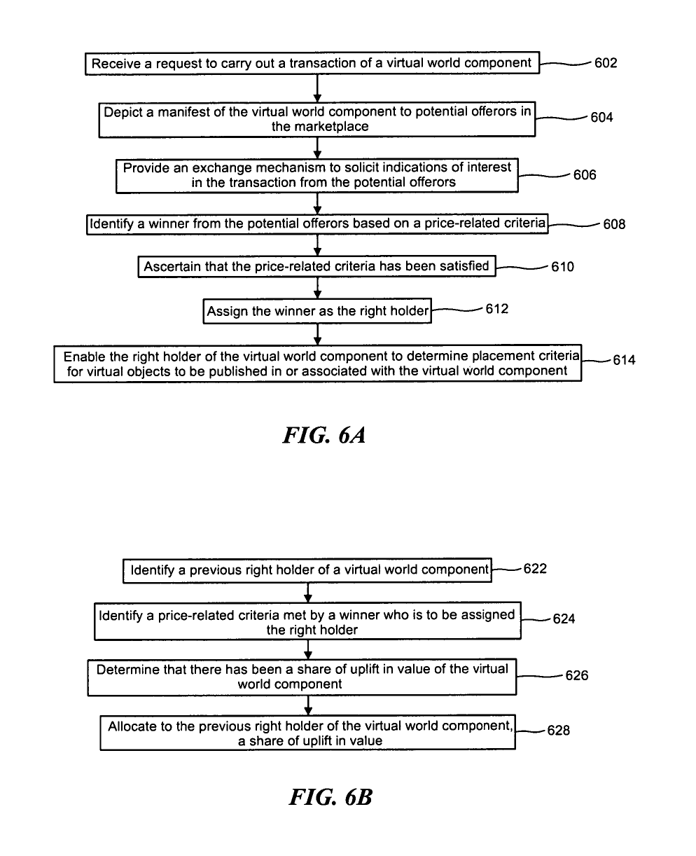

FIG. 6A depicts a flow chart illustrating an example process for to administer a marketplace for a virtual world component of an augmented reality environment, in accordance with embodiments of the present disclosure.

In process 602 a request to carry out a transaction of a virtual world component is received. In one embodiment, the request includes a request to sell the virtual world component. For example, a current or existing rightholder of the virtual world component can initiate a request to sell the virtual world component to another entity (e.g., a person, an organization, a company, a bot or robot, etc.). The sales to the other entity can be a transfer of all rights to the virtual world component, for a permanent or limited amount of time (which may be fixed, flexible or renewable). During ownership, an entity typically possess rights such as right to sale, right to transfer, assign, rights to license out or lease out all or part of the virtual world component. The entity who owns the virtual world component also typically decides how, where, when, the virtual world component is used, who uses it.

Uses of the virtual world component can include publication or association of content such as virtual objects or other digital or electronic items with any portion of the virtual world component. The virtual world component, typically forms an augmented reality environment that can be deployed for a physical place associated with the virtual world component. In rendering or depicting the augmented reality environment, the content that is associated with any portion of the virtual world component is typically depicted as being associated in location with the physical place (e.g., in the vicinity of the physical place or at the physical place). For example, the content can appear as being visually super imposed over or near the physical place when observed from a user interface or device. As such, virtual world components associated with certain physical locations may be more valuable to one entity relative to others. Such value can be the driver in the supply and demand for virtual world components.

The owner can also determine lease or license terms to a licensee, lessee or renter. The owner can determine whether a licensor, renter or lessee has the rights to sublease, sublicense the virtual world component. The owner can impose any restrictions a licensee, lessee or renter's ability to control the association of digital content (e.g., VOBs) with the virtual world component. Note that different lease terms can apply to different parts of the virtual world component as the owner can enter separate agreements embodying different terms for different parts or units of the virtual world component.

In one embodiment, the request can include a request to lease out (rent out), or sub-lease out the virtual world component. The request can be initiated by the owner, leaser holder, licensor or other permanent or temporary rightholder. The request to lease out or sublet the virtual world component can also be automatically triggered responsive to a lease, sublease or license term expiring or near expiring.

In one embodiment, the request also include a request to acquire, lease or sublease the virtual world component. These requests can be triggered or initiated by entity wishing to acquire or lease the virtual world component from a current owner, or a sub-lessee from a current lessee.

In a further embodiment, the request to carry out the transaction of the virtual world component, can be triggered in response to detection of a specification of parameters of a physical space with which the virtual world component is associated. For example, any entity can choose any region of virtual real-estate corresponding to a region of the physical world, so long as that region is not yet owned or rented by another entity. A transaction of that region of virtual real-estate can then be triggered or initiated.

In process 604, a manifest of the virtual world component to potential offerors in the marketplace is depicted. The manifest of the virtual world component can include, for example, a first parameter indicia to identify parameters of a physical space with which the virtual world component is associated. The parameters of the physical space can include, a physical region specified by for example, longitude, latitude, latitude, x-axis, y-axis, z-axis, or names of locations, cities, states, countries, municipalities, land or property, one or more addresses, or any other identifiers. The physical region can also take on a 2 (e.g., a surface, plane), or 3D shape or form, as illustrated in the examples of FIG. 5B. The physical region can also be a dot.

The manifest can also include a second parameter indicia to specify a term which underpins the transaction. For example, a term can specify, whether the transaction is a sale, a purchase, a lease, sub-lease or a license (license to use) and any other rights or restrictions of the transaction, along with an applicable period of time of a lease, sub-lease or license.

A license to use, can be an agreement for the licensee to use the virtual world component (e.g., virtual space) for a certain amount of time for specific purposes(s)). For example, an owner, landlord or lessee of the virtual world component, or a portion of the virtual world component which corresponds to or is associated with a physical in the region of a McDonald's store front, or associated with physical space that is within 10 miles of McDonald's can enter into an agreement with McDonald's to associate digital content (e.g., a digital billboard, ads, promotions) relating to McDonald's goods and offerings at certain times of the day, and/or positioned at certain levels of heights. The owner may only allow McDonald's to place, publish or otherwise associate objects or content that are relevant to the goods, offerings of McDonald's to the virtual world component, or a portion of the virtual world component that it is the rightholder of.

In process 606, an exchange mechanism is provided to solicit indications of interest in the transaction from the potential. The exchange mechanism can indue a fixed price offering associated with an asking price for the virtual world component. The asking price can be determined by an offeree of the virtual world component. The offeree can be an owner, lessor, licensor or other right holder setting the price to purchase, or price to rent or license the virtual world component from them.

The asking price can also be determined (e.g., system determined by the exchange mechanism) based on demand. The system can ascertain the level of interest in the virtual world component, size of implicated market, and historical prices and generate a pricing model for the virtual world component. The system determined price can be constantly updated in real time or near real time based on real time demand, real time comparable supplies, comparable sales, interest in the virtual world component. Willingness of either party (offeree and prospective offerors) to transact can also be factored into the pricing model.

In a further embodiment, the exchange mechanism can include an auction offering which enables the potential offerers to bid for the virtual world component. In an auction type like offering, the ultimate price to consummate the transaction of the virtual world component typically is determined by a highest bidder.

In process 608, a winner is identified from the potential offerors based on a price-related criteria. The price-related criteria can include, a winning bid, a purchase cost, a cost to lease, sub-lease, license, or a cost to renew a lease to the virtual world component. For example, the winner can be the entity among the potential offerors to offer to or to enter into a contract or agreement to pay the fixed price for the transaction. The winner may also be the entity to submit the highest bid in an auction for the virtual world component.

Ultimately, the winner can be designated as the rightholder, of the virtual world component. The winner may be the initial rightholder, if the virtual world component has not had a previous right owner before. For example, if the virtual world component has not had an owner, landlord, or other lease holder before the winner. There can also have been a previous rightholder who was an owner, landlord, tenant, leaseholder or other right holder before the current winner.

In process 610, it is ascertained that the price-related criteria has been satisfied. For example, the price-related criteria can be met when the winner pays the price, pays a deposit or down payment, pays the rent for a certain period of the lease, or satisfies a payment requirement of licensing terms. The winner may also need to enter into a contract or agreement with the offeror of the virtual world component. In process 612, the winner is assigned as the rightholder.

In process 614, the rightholder of the virtual world component is enabled to determine placement criteria for virtual objects to be published in or associated with the virtual world component. For example, the rightholder can possess the rights to place content or objects into the virtual world component for depiction in an AR environment associated with the physical place. The rightholder may also permit other select entities to publish their content or objects for example, with an applicable fee (e.g., sale or rights, or a license to another entity) and/or with certain restrictions and criteria.

FIG. 6B depicts a flow chart illustrating an example process for managing and facilitating investments in virtual real-estate (VRE), in accordance with embodiments of the present disclosure.

Note that in accordance with the present disclosure, owning or renting virtual real-estate can be a form of investment. Any rightholder can potentially benefit from virtual real-estate (e.g., owner, landlord, lessor, licensor, etc.). For example, if the value increases they can benefit from the increase in value.

In process 622, a previous rightholder of a virtual world component is identified. In process 624, a price-related criteria that has been met by a winner who is to be assigned the rightholder is identified. In process 626, it is determined that there has been a share of uplift in value of the virtual world component. In process 628, a share of uplift in value is allocated to the previous right holder of the virtual world component.

For example, the previous rightholder (e.g., previous owner, previous lessee, or previous licensor or licensee) can be given some percentage of any increased price paid when the VRE is next sold or when a new lease is signed for the virtual real-estate. In this way if the previous rightholder invest to lease virtual real-estate and the value increases when their lease expires, the previous rightholder can renew and keep it, or if someone else wins the auction to lease it then the previous rightholder can get a revenue share (in some currency or points system) of the new higher price.

In one embodiment, if a part of the virtual world component is transacted, the system can compute how much the previous rightholder receives of any increase in value after the virtual world component has been subdivided, This computation can take into account, fractional increases in value from totally overlapping or partially overlapping subdivisions of it that are subsequently sold or leased

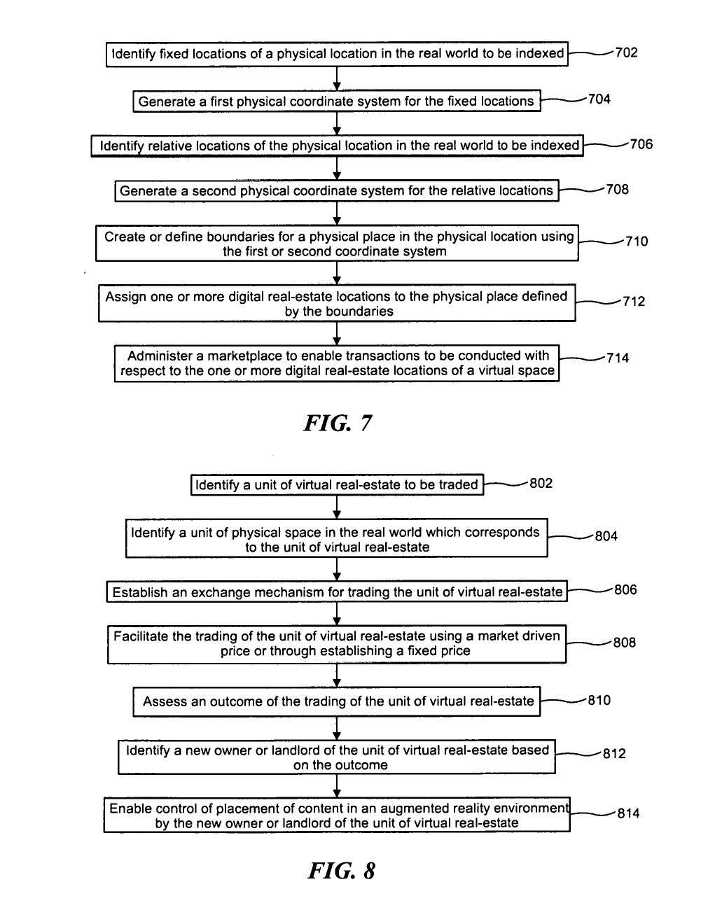

FIG. 7 depicts a flow chart illustrating an example process to index a physical location in the real world, in accordance with embodiments of the present disclosure.

Embodiments of the present disclosure are, in one embodiment, related to monetizing and trading virtual spaces of an augmented reality environment that correspond to physical locations in the physical world. The virtual spaces can correspond to a coordinate system of fixed physical locations (e.g., a street, a city, a landmark like the Eiffel Tower, Statue of liberty, the city of San Francisco, Central Park, a Starbucks store, etc.). The virtual spaces can also correspond to relative physical locations that correspond to local coordinate systems around people or physical thing or objects that can have fixed locations and can move around the real physical world

In process 702, fixed locations of a physical location in the real world to be indexed are identified. Note that fixed locations or the relative locations can be specified by, one or more of, longitude, latitude, latitude, x-axis, y-axis, z-axis, or names of locations, cities, states, countries, municipalities, land or property, one or more addresses. In process 704, a first physical coordinate system is generated for the fixed locations.

In process 706, relative locations of the physical location in the real world to be indexed are identified. The relative locations can for example, correspond to people or physical things that are moveable in the real world. For example, There can also be a relative physical coordinate system for the physical space around and relative to any person or any physical product that can move, or any physical object. In process 708, a second physical coordinate system for the relative locations is generated.

A physical coordinate system can be generated to index locations in physical space relative to any physical thing, object, person or place. For example, there can be a physical coordinate system for the physical space relative to the earth (e.g., as illustrated by way of examples of FIG. 5A and FIG. 5C). Embodiments of the present disclosure also include a physical coordinate system for the physical space relative to or in the universe (as illustrated in the example of FIG. 5D).

In process 710, boundaries for a physical place in the physical location are defined or created using the first or second coordinate system. In one embodiment, alternatively to a rigid grid of virtual real-estate plots, the system can enable the virtual real-estate plots to be defined in an emergent manner. For example, users or entities can define or specify boundaries of the physical location using the first or second coordinate systems. The user defined boundaries can be of any form or shape and take on any number of dimensions. Enabling boundaries of plots to be customized allows for irregular shapes of virtual real-estate to be defined and traded. For example, an entity can buy all of Manhattan. An entity can also buy any number of units of virtual real-estate the corresponds the irregular shape of the boundary of a place in the physical world such as a college campus or a public park.

In process 712, one or more digital real-estate locations (e.g., virtual real-estate locations, layers) of a virtual space are assigned to the physical place defined by the boundaries. For a given physical place, there can be a corresponding digital real-estate location or multiple corresponding digital real-estate locations in the virtual space. This can be a one to one relationship; one to many, or many to many relationship. Note that the one or more digital real-estate locations exist in the virtual space usable to augment the real world in digital applications to facilitate and enable activities with respect to the physical location.

In process 714, a marketplace is administered to enable transactions to be conducted with respect to the one or more digital real-estate locations of the virtual space. The transactions to be conducted include, one or more of buying, renting, leasing, selling, sub-leasing, licensing or sub-licensing the one or more virtual real estate location.

The disclosed system generates or overlays a marketplace for virtual real-estate that corresponds to units of physical space (e.g., every square centimetre, every square meter, square feet, etc.) on the surface of the Earth at varying altitudes. As such a grid of virtual real estate locations can be in the form of virtual dots, two-dimensional shapes (e.g., squares, triangles, circles, ovals, or other shapes) and/or cubes or other 3D shapes of various sizes.

A unit (e.g., dot, 2D representation and/or three dimensional (e.g., cube or any other shape)) of virtual real-estate (VRE) can be associated with and represents a corresponding unit (e.g., dot, two-dimensional representation and/or three dimensional (e.g., cube)) of physical space in the physical coordinate system. The unit of VRE can have associated with it a price-related criteria for the transaction (e.g., a price to buy, license, sublicense, lease, or sublease it for a period of time.)

In a further example, the system can generate a grid of virtual real-estate that is assigned to subdivisions of the physical space around and relative to people, places, things in the real world, or around and relative to each moveable physical object in motion or while stationary.

In one embodiment, the system can define a grid of VRE locations, divided for example into a grid of 10 meter×10 meter×10 meter cubes. Each of these cubes is a unit of virtual real-estate that can be assigned to correspond with the corresponding 10×10×10 meter cube (or other shape, dimension, or size) of physical space on or around Earth. A price can be set to buy, lease, or sub-lease each cube of virtual real-estate. The price can be set as a fixed price, or as a market-driven price via an auction mechanism, or by market supply and demand. People and organizations (buyers) can compete to buy, lease or sub-lease particular regions of virtual real-estate that represent particular regions of the physical world.

FIG. 8 depicts a flow chart illustrating an example process to facilitate trade or exchange of virtual real-estate (VRE), in accordance with embodiments of the present disclosure.

In process 802, a unit of virtual real-estate (VRE) to be traded is identified. The unit of virtual real-estate to be traded is identified in response to determining that an owner or lessor of the unit of the virtual real-estate requests to trade the unit of virtual real-estate. In process 804, a unit of physical space in the real world which corresponds to the unit of virtual real-estate is identified.

In one embodiment, the unit of VRE to be traded can also be identified or detected when an entities defines or specifies boundaries of the unit of VRE and enquires about its availability or ownership status. If the requested unit of VRE is offered for purchase or rent, its trade or exchange process can take place. In addition, if the requested unit of VRE does not have a rightholder, the disclosed system can also initiate a process to facilitate its trade or exchange.

Similarly, an entity can define or specify the boundaries of the unit of physical space for the corresponding unit of VRE for which it wishes to obtain rights to. In this manner, virtual real-estate parcels emerge in a bottom-up fashion to be any shape and size, irregular or regular, and in any dimension (1D, 2D, 3D, or multi-dimensions). When an entity claims or requests to acquire the rights to the unit of virtual space (either by explicitly defining its parameters or by identifying the corresponding unit of physical real estate), the disclosed system can initiate a trade or exchange process (e.g., fixed price sale or an auction-like process).

In process 806, an exchange mechanism for trading the unit of virtual real-estate is established. The exchange mechanism can include, for example, one or more of, a purchase facility, a sale facility, a lease facility, sub-lease facility, and/or a license facility to trade the unit of virtual real estate. In process 808, the trading of the unit of virtual real-estate is facilitated using a market driven price or through establishing a fixed price. For example, an auction or an auction like process for the unit of virtual real-estate is hosted to determine the market driven price. In process 810, an outcome of the trading of the unit of virtual real-estate is assessed. In process 810, a new owner or landlord of the unit of virtual real-estate is identified based on the outcome.

Note that the unit of virtual real-estate, forms at least a portion of a virtual space which can be digitally rendered over a representation the physical space. The virtual space is rendered such that, as observed by a human user, the virtual space appears to be visually superimposed over the representation of the physical place in the real world. In one embodiment, depiction of the virtual space over a photorealistic rendering of the physical space forms an augmented reality environment of the physical place. In process 812, the new owner or landlord of the unit of virtual real-estate is enabled to control of placement of content the augmented reality environment.

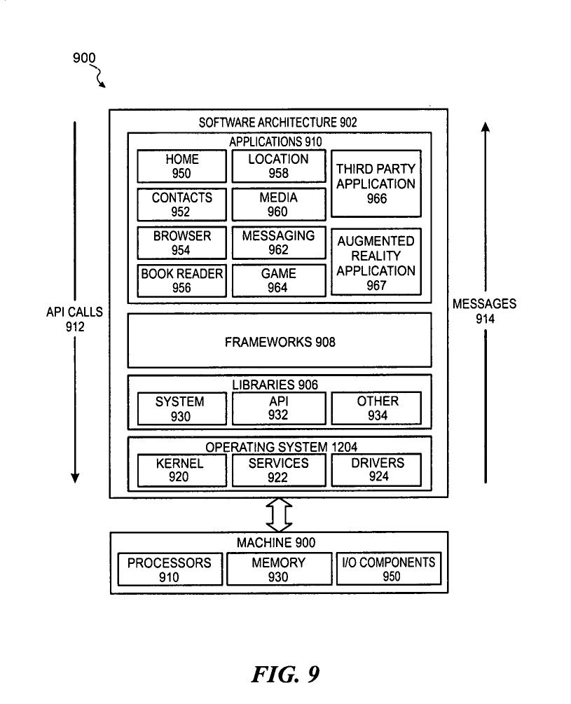

FIG. 9 is a block diagram illustrating an example of a software architecture 900 that may be installed on a machine, in accordance with embodiments of the present disclosure.

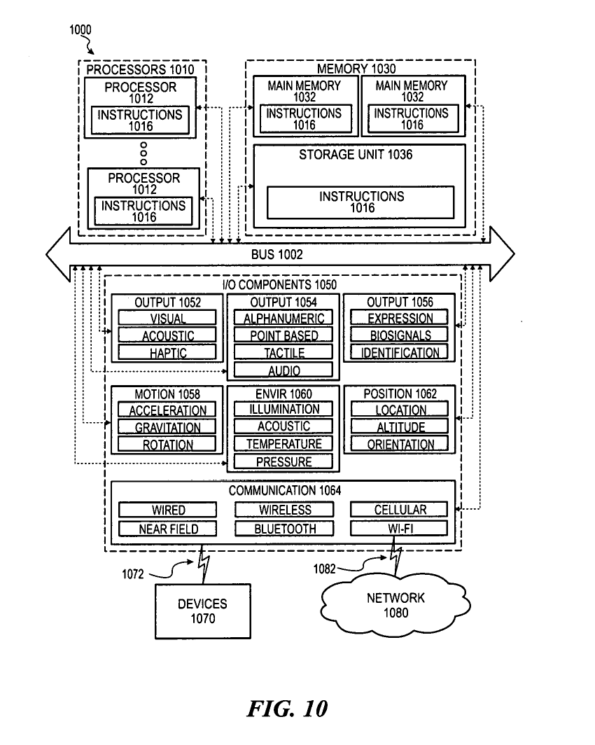

FIG. 9 is a block diagram 900 illustrating an architecture of software 902, which can be installed on any one or more of the devices described above. FIG. 9 is a non-limiting example of a software architecture, and it will be appreciated that many other architectures can be implemented to facilitate the functionality described herein. In various embodiments, the software 902 is implemented by hardware such as machine 1000 of FIG. 10 that includes processors 1010, memory 1030, and input/output (I/O) components 1050. In this example architecture, the software 902 can be conceptualized as a stack of layers where each layer may provide a particular functionality. For example, the software 902 includes layers such as an operating system 904, libraries 906, frameworks 908, and applications 910. Operationally, the applications 910 invoke API calls 912 through the software stack and receive messages 914 in response to the API calls 912, in accordance with some embodiments. In one example, the VRE exchange 340 operates as an application 910.

In some embodiments, the operating system 904 manages hardware resources and provides common services. The operating system 904 includes, for example, a kernel 920, services 922, and drivers 924. The kernel 920 acts as an abstraction layer between the hardware and the other software layers consistent with some embodiments. For example, the kernel 920 provides memory management, processor management (e.g., scheduling), component management, networking, and security settings, among other functionality. The services 922 can provide other common services for the other software layers. The drivers 924 are responsible for controlling or interfacing with the underlying hardware, according to some embodiments. For instance, the drivers 924 can include display drivers, camera drivers, BLUETOOTH drivers, flash memory drivers, serial communication drivers (e.g., Universal Serial Bus (USB) drivers), WI-FI drivers, audio drivers, power management drivers, and so forth.

In some embodiments, the libraries 906 provide a low-level common infrastructure utilized by the applications 910. The libraries 906 can include system libraries 930 (e.g., C standard library) that can provide functions such as memory allocation functions, string manipulation functions, mathematics functions, and the like. In addition, the libraries 906 can include API libraries 932 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 906 can also include a wide variety of other libraries 934 to provide many other APIs to the applications 910.

The frameworks 908 provide a high-level common infrastructure that can be utilized by the applications 910, according to some embodiments. For example, the frameworks 908 provide various graphic user interface (GUI) functions, high-level resource management, high-level location services, and so forth. The frameworks 908 can provide a broad spectrum of other APIs that can be utilized by the applications 910, some of which may be specific to a particular operating system 904 or platform.

In an example embodiment, the applications 910 include a home application 950, a contacts application 952, a browser application 954, a search/discovery application 956, a location application 958, a media application 960, a messaging application 962, a game application 964, and other applications such as a third party application 966. According to some embodiments, the applications 910 are programs that execute functions defined in the programs. Various programming languages can be employed to create one or more of the applications 910, structured in a variety of manners, such as object-oriented programming languages (e.g., Objective-C, Java, or C++) or procedural programming languages (e.g., C or assembly language). In a specific example, the third party application 966 (e.g., an application developed using the Android, Windows or iOS. software development kit (SDK) by an entity other than the vendor of the particular platform) may be mobile software running on a mobile operating system such as Android, Windows or iOS, or another mobile operating systems. In this example, the third party application 966 can invoke the API calls 912 provided by the operating system 904 to facilitate functionality described herein.

An augmented reality application 967 may implement any system or method described herein, including integration of augmented, alternate, virtual and/or mixed realities for digital experience enhancement, or any other operation described herein.

FIG. 10 is a block diagram illustrating components of a machine 1000, according to some example embodiments, able to read a set of instructions from a machine-readable medium (e.g., a machine-readable storage medium) and perform any one or more of the methodologies discussed herein.

Specifically, FIG. 10 shows a diagrammatic representation of the machine 1000 in the example form of a computer system, within which instructions 1016 (e.g., software, a program, an application, an applet, an app, or other executable code) for causing the machine 1000 to perform any one or more of the methodologies discussed herein can be executed. Additionally, or alternatively, the instruction can implement any module of FIG. 3A and any module of FIG. 4A, and so forth. The instructions transform the general, non-programmed machine into a particular machine programmed to carry out the described and illustrated functions in the manner described.

In alternative embodiments, the machine 1000 operates as a standalone device or can be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 can comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a headmounted device, a smart lens, goggles, smart glasses, a smart home device (e.g., a smart appliance), other smart devices, a web appliance, a network router, a network switch, a network bridge, a Blackberry, a processor, a telephone, a web appliance, a console, a hand-held console, a (hand-held) gaming device, a music player, any portable, mobile, hand-held device or any device or machine capable of executing the instructions 1016, sequentially or otherwise, that specify actions to be taken by the machine 1000. Further, while only a single machine 1000 is illustrated, the term “machine” shall also be taken to include a collection of machines 1000 that individually or jointly execute the instructions 1016 to perform any one or more of the methodologies discussed herein.

The machine 1000 can include processors 1010, memory/storage 1030, and I/O components 1050, which can be configured to communicate with each other such as via a bus 1002. In an example embodiment, the processors 1010 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) can include, for example, processor 1012 and processor 1014 that may execute instructions 1016. The term “processor” is intended to include multi-core processor that may comprise two or more independent processors (sometimes referred to as “cores”) that can execute instructions contemporaneously. Although FIG. 10 shows multiple processors, the machine 1000 may include a single processor with a single core, a single processor with multiple cores (e.g., a multi-core processor), multiple processors with a single core, multiple processors with multiples cores, or any combination thereof.

The memory/storage 1030 can include a main memory 1032, a static memory 1034, or other memory storage, and a storage unit 1036, both accessible to the processors 1010 such as via the bus 1002. The storage unit 1036 and memory 1032 store the instructions 1016 embodying any one or more of the methodologies or functions described herein. The instructions 1016 can also reside, completely or partially, within the memory 1032, within the storage unit 1036, within at least one of the processors 1010 (e.g., within the processor's cache memory), or any suitable combination thereof, during execution thereof by the machine 1000. Accordingly, the memory 1032, the storage unit 1036, and the memory of the processors 1010 are examples of machine-readable media.

As used herein, the term “machine-readable medium” or “machine-readable storage medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) or any suitable combination thereof. The term “machine-readable medium” or “machine-readable storage medium” should be taken to include a single medium or multiple media (e.g., a centralized or distributed database, or associated caches and servers) able to store instructions 1016. The term “machine-readable medium” or “machine-readable storage medium” shall also be taken to include any medium, or combination of multiple media, that is capable of storing, encoding or carrying a set of instructions (e.g., instructions 1016) for execution by a machine (e.g., machine 1000), such that the instructions, when executed by one or more processors of the machine 1000 (e.g., processors 1010), cause the machine 1000 to perform any one or more of the methodologies described herein. Accordingly, a “machine-readable medium” or “machine-readable storage medium” refers to a single storage apparatus or device, as well as “cloud-based” storage systems or storage networks that include multiple storage apparatus or devices. The term “machine-readable medium” or “machine-readable storage medium” excludes signals per se.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

The I/O components 1050 can include a wide variety of components to receive input, provide output, produce output, transmit information, exchange information, capture measurements, and so on. The specific I/O components 1050 that are included in a particular machine will depend on the type of machine. For example, portable machines such as mobile phones will likely include a touch input device or other such input mechanisms, while a headless server machine will likely not include such a touch input device. It will be appreciated that the I/O components 1050 can include many other components that are not shown in FIG. 10. The I/O components 1050 are grouped according to functionality merely for simplifying the following discussion and the grouping is in no way limiting. In example embodiments, the I/O components 1050 can include output components 1052 and input components 1054. The output components 1052 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1054 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), eye trackers, and the like.

In further example embodiments, the I/O components 1050 can include biometric components 1056, motion components 1058, environmental components 1060, or position components 1062 among a wide array of other components. For example, the biometric components 1056 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1058 can include acceleration sensor components (e.g., an accelerometer), gravitation sensor components, rotation sensor components (e.g., a gyroscope), and so forth. The environmental components 1060 can include, for example, illumination sensor components (e.g., a photometer), temperature sensor components (e.g., one or more thermometers that detect ambient temperature), humidity sensor components, pressure sensor components (e.g., a barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 1062 can include location sensor components (e.g., a GPS receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 1050 may include communication components 1064 operable to couple the machine 1000 to a network 1080 or devices 1070 via a coupling 1082 and a coupling 1072, respectively. For example, the communication components 1064 include a network interface component or other suitable device to interface with the network 1080. In further examples, communication components 1064 include wired communication components, wireless communication components, cellular communication components, Near Field Communication (NFC) components, Bluetooth. components (e.g., Bluetooth. Low Energy), WI-FI components, and other communication components to provide communication via other modalities. The devices 1070 may be another machine or any of a wide variety of peripheral devices (e.g., a peripheral device coupled via a USB).

The network interface component can include one or more of a network adapter card, a wireless network interface card, a router, an access point, a wireless router, a switch, a multilayer switch, a protocol converter, a gateway, a bridge, bridge router, a hub, a digital media receiver, and/or a repeater.

The network interface component can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure.

Moreover, the communication components 1064 can detect identifiers or include components operable to detect identifiers. For example, the communication components 1064 can include Radio Frequency Identification (RFID) tag reader components, NFC smart tag detection components, optical reader components (e.g., an optical sensor to detect one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 1364, such as location via Internet Protocol (IP) geo-location, location via WI-FI signal triangulation, location via detecting a BLUETOOTH or NFC beacon signal that may indicate a particular location, and so forth.

In various example embodiments, one or more portions of the network 1080 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a WI-FI® network, another type of network, or a combination of two or more such networks. For example, the network 1080 or a portion of the network 1080 may include a wireless or cellular network, and the coupling 1082 may be a Code Division Multiple Access (CDMA) connection, a Global System for Mobile communications (GSM) connection, or other type of cellular or wireless coupling. In this example, the coupling 1382 can implement any of a variety of types of data transfer technology, such as Single Carrier Radio Transmission Technology, Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, 5G, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1016 can be transmitted or received over the network 1080 using a transmission medium via a network interface device (e.g., a network interface component included in the communication components 1064) and utilizing any one of a number of transfer protocols (e.g., HTTP). Similarly, the instructions 1016 can be transmitted or received using a transmission medium via the coupling 1072 (e.g., a peer-to-peer coupling) to devices 1070. The term “transmission medium” shall be taken to include any intangible medium that is capable of storing, encoding, or carrying the instructions 1016 for execution by the machine 1000, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the innovative subject matter has been described with reference to specific example embodiments, various modifications and changes may be made to these embodiments without departing from the broader scope of embodiments of the present disclosure. Such embodiments of the novel subject matter may be referred to herein, individually or collectively, by the term “innovation” merely for convenience and without intending to voluntarily limit the scope of this application to any single disclosure or novel or innovative concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. § 112, ¶ 6, other aspects may likewise be embodied as a means-plus-function claim, or in other forms, such as being embodied in a computer-readable medium. (Any claims intended to be treated under 35 U.S.C. § 112, ¶ 6 will begin with the words “means for”.) Accordingly, the applicant reserves the right to add additional claims after filing the application to pursue such additional claim forms for other aspects of the disclosure.

1. A method to administer a marketplace for a virtual world component of an augmented reality environment:
responsive to a request to carry out a transaction of the virtual world component;
depicting a manifest of the virtual world component to one or more potential offerors in the marketplace;
providing an exchange mechanism to solicit indications of interest in the transaction from the one or more potential offerors;
identifying a winner from the one or more potential offerors based on a price-related criteria;
wherein, the winner is to be designated as a right older of the virtual world component.

2. The method of claim 1, wherein, the request includes a request to sell, rent out, acquire, lease or sublease the virtual world component.

3. (canceled)

4. The method of claim 1, wherein, the request to carry out the transaction of the virtual world component, is triggered in response to:
detecting specification of parameters of a physical space with which the virtual world component is associated.

5. The method of claim 1, wherein, the manifest of the virtual world component includes, one or more of:
a first parameter indicia to identify parameters of a physical space with which the virtual world component is associated;
a second parameter indicia to specify a term which underpins the transaction.

6. The method of claim 5, wherein, the term of the transaction identifies whether the virtual world component is available for purchase, for lease, or for sub-lease.

7. (canceled)

8. The method of claim 1, wherein, the exchange mechanism includes a fixed price offering associated with an asking price for the virtual world component; wherein, the asking price is determined by an office of the virtual world component or system determined based on demand.

9. (canceled)

10. The method of claim 1, wherein, the exchange mechanism includes an auction offering which enables the potential offerors to bid for the virtual world component.

11. The method of claim 1, further comprising:
identifying a previous rightholder of the virtual world component;
allocating to the previous right holder of the virtual world component, a share of uplift in value of the virtual world component, based on the price-related criteria met by the winner to be assigned as the rightholder;
wherein, the price-related criteria includes, a winning bid, a purchase cost, a cost to lease, or a cost to renew a lease to the virtual world component.

12. The method of claim 1, further comprising,
responsive to ascertaining that the price-related criteria has been satisfied, assigning the winner as the rightholder;
enabling the rightholder of the virtual world component determine placement criteria for virtual objects to be published in or associated with the virtual world component.

13. A machine-readable storage medium, having stored thereon instructions, which when executed by a processor, cause the processor to implement a method to index a physical location in the real world, the method, comprising:
identifying fixed locations of the physical location in the real world to be indexed;
generating a first physical coordinate system for the fixed locations;
identifying relative locations of the physical location in the real world to be indexed;
generating a second physical coordinate system for the relative locations.

14. The method of claim 13, wherein, the relative locations correspond to people or physical things that are movable in the real world.

15. (canceled)

16. The method of claim 13, further comprising:
creating or defining boundaries for a physical place in the physical location with the first or second coordinate system or enabling users to define or specify boundaries of the physical location using the first or second coordinate systems;
assigning one or more digital real-estate locations to the physical place defined by the boundaries;
wherein the one or more digital real-estate locations exist in a virtual space usable to augment the real world in digital applications to facilitate and enable activities with respect to the physical location.

17. (canceled)

18. the method of claim 16, further comprising, administering a marketplace to enable transactions to be conducted with respect to the one or more digital real-estate locations of the virtual space; wherein, the transactions to be conducted include, one or more of buying, leasing, selling, sub-leasing the one or more virtual real estate location.

19. (canceled)

20. A system to facilitate trade or exchange of virtual real-estate, the system, comprising:
a processor;
memory having stored having stored thereon instructions, which when executed by a processor, cause the processor to:
identify a unit of virtual real-estate to be traded;
identify a unit of physical space in the real world which corresponds to the unit of virtual real-estate;
establish an exchange mechanism for trading the unit of virtual real-estate;

21. The system of claim 20, wherein:
the unit of virtual real-estate to be traded is identified in response to determining that an owner or lessor of the unit of the virtual real-estate requests to trade the unit of virtual real-estate;
the exchange mechanism includes one or more of, a purchase facility, a sale facility, a lease facility, sub-lease facility to trade the unit of virtual real estate.

22. The system of claim 20, wherein the unit of physical space takes on 2D or 3D shape or form, or in the form of a dot.

23. (canceled)

24. (canceled)

25. The system of claim 20, wherein, the processor:
facilitates the trading of the unit of virtual real-estate through establishing a fixed price in the exchange mechanism.

26. The system of claim 20, wherein, the processor:
facilitates the trading of the unit of virtual real-estate using a market driven price;
hosts an auction of the unit of virtual real-estate to determine the market driven price.

27. The system of claim 20, wherein:
the unit of virtual real-estate, forms at least a portion of a virtual space which is digitally rendered over a representation the physical space;
the virtual space is rendered such that, as observed by a human user, the virtual space appears to be visually superimposed over the representation of the physical place in the real world.

28. The system of claim 20, wherein:
depiction of the virtual space over a photorealistic rendering of the physical space forms an augmented reality environment of the physical place;
placement of content in the augmented reality environment is controlled at least in part by a new owner or landlord of the unit of the virtual real-estate determined via an outcome of the trading of the unit of virtual real estate.
